(19) United States
(12) Patent Application Publication
(10) Pub. No.: US 2011/0147128 A1
(43) Pub. Date: Jun. 23, 2011

(54) Method of manufacturing a base body of an oil pan and an oil pan base body manufactured by such a method

(75) Inventors: Marco Schrade, Hayingen (DE); Klaus Bendl, Oberderdingen (DE)

(73) Assignee: ElringKlinger AG

(21) Appl. No.: 12/928,348

(22) Filed: Dec. 9, 2010

(30) Foreign Application Priority Data
Dec. 22, 2009 (DE) 10 2009 055 157.3

(51) Int. Cl. F16N 31/02; B29C 45/22; B29C 45/76

(52) U.S. Cl. 184/106; 264/255; 264/40.3

(57) ABSTRACT

In order to provide a method of manufacturing a base body of an oil pan by means of which there can be produced a mechanically highly stable base body of an oil pan which, to a large extent, maintains its shape after the manufacturing process, there is proposed a method of manufacturing a base body of an oil pan which comprises the following process step:
filling an injection mould having a complementary shape to the base body with a flowable starting material utilising a cascade injection moulding process.

### RELATED APPLICATION

The present disclosure relates to the subject matter which was disclosed in the German patent application No. 10 2009 055 157.3 dated 22 Dec. 2009. By reference thereto, the entire description of this earlier application is incorporated in the content of the present description (“incorporation by reference”).

### FIELD OF DISCLOSURE

The present invention relates to a method of manufacturing a base body of an oil pan.

### BACKGROUND

Such oil pans, which are known from the state of the art, serve for accommodating a reservoir of engine oil for an internal combustion engine and are fixed to an engine block of the internal combustion engine.

It is known to manufacture such oil pans from a molten metal and in particular, from aluminium utilising a casting process.

A base body for an oil pan can also be made from a synthetic material utilising an injection moulding process.

### SUMMARY OF THE INVENTION

The object of the present invention is to provide a method of manufacturing a base body of an oil pan by means of which there can be produced an oil pan base body that is mechanically highly stable and which, to a large extent, retains its shape after the manufacturing process.

In accordance with the invention, this object is achieved by a method of manufacturing a base body of an oil pan which comprises the following process step:
filling an injection mould of complementary shape to the base body with a flowable starting material in a cascade injection moulding process.

In a cascade injection moulding process, the cavity of an injection mould is filled sequentially with the flowable starting material by means of a plurality of nozzles, whereby the nozzles are opened in timed succession by a control device by means of which closure devices of the nozzles are controllable.

In this way, it is even possible to manufacture large base bodies of considerable longitudinal extent, such as are needed in particular for the oil pans of engines used in utility vehicles, by utilising an injection moulding technique wherein the filling process is effected by means of a plurality of mutually spaced nozzles but wherein the production of joint lines is prevented, such joint lines occurring in a conventional injection moulding process utilising a plurality of nozzles at the points where the flow fronts of the starting material emerging from different but simultaneously opened nozzles meet one another.

Due to the omission of the joint lines which would otherwise produce a weakening in the structure of the manufactured base body, the base body of the oil pan manufactured by means of a cascade injection moulding process exhibits particularly good mechanical stability.

Moreover, the side walls of a base body of an oil pan which is manufactured by means of a cascade injection moulding process make less of an incursion towards the longitudinal centre plane of the base body after it is expelled from the mould.

The shape of the base body manufactured in accordance with the invention is thus more true and of greater stability.

Preferably, the starting material is introduced into the injection mould through at least two mutually spaced nozzles, these nozzles being opened successively.

It is particularly expedient thereby, for a first nozzle to be opened initially and for a second nozzle to be opened after the first nozzle following a temporal delay which is such that the flow front of the starting material emerging from the first nozzle has reached or already passed the second nozzle when the second nozzle is opened. In this way, the formation of joint lines in the finished manufactured base body is reliably prevented since there is only a single flow front for the starting material travelling through the cavity of the injection mould.

In a preferred embodiment of the method in accordance with the invention, provision is made for at least three nozzles to be opened in succession, wherein the sequence of the time points at which the nozzles are opened corresponds to the sequential positions of the nozzles in a longitudinal direction of the base body.

Preferably, provision is made for the first nozzle or the first nozzles to be opened to introduce the starting material into a flange region of the injection mould in which a mounting flange of the base body of the oil pan is formed. The effect is thereby achieved that the process of filling the flange region of the cavity of the injection mould has been concluded before the remaining regions of the cavity are filled so that joint lines are prevented from developing especially in the particularly heavily mechanically stressed mounting flange of the base body being manufactured.

In principle, the opening time points of the nozzles can be fixed so that the successive opening of a plurality of nozzles is controlled in dependence on the elapsed filling time.

As an alternative or in addition thereto, provision may also be made for the successive opening of a plurality of nozzles to be controlled in dependence on the quantity of starting material that has been introduced into the injection mould. In this case, a new nozzle is opened when the quantity of flowable starting material that has been supplied to the cavity has reached a certain value.

In order to make this possible, a flow rate measuring instrument can be provided in the line used for supplying the starting material to the nozzles.

As an alternative or in addition thereto, provision may also be made for the successive opening of a plurality of nozzles to be controlled in dependence on a pressure prevailing within a cavity of the injection mould.

To this end, at least one pressure sensor is provided within the cavity, said pressure sensor serving to measure the internal pressure in the cavity which increases when the flow front of the starting material being filled into the cavity reaches the pressure sensor concerned.

In this case, a plurality of pressure sensors are preferably arranged in the cavity for the purposes of controlling the opening time points of a plurality of nozzles, each said pressure sensor being associated with a respective one of the nozzles that are to be controlled.

In a preferred embodiment of the method in accordance with the invention, the base body of the oil pan being manufactured comprises a deep region and a flat region which extends away from the deep region in a longitudinal direction of the base body. In this case in particular, the cavity of the injection mould can be filled commencing from an end region of the deep region that is remote from the flat region of the base body being formed or commencing from an end region of the flat region that is remote from the deep region of the base body being formed.

Preferably hereby, provision is made for that nozzle to be opened first which is closest to an end region of the flat region of the base body that is remote from the deep region of the base body of the oil pan.

In particular, the starting material with which the cavity of the injection mould is filled may comprise a thermoplastic synthetic material and is preferably formed substantially entirely from a thermoplastic synthetic material.

A particularly suitable thermoplastic synthetic material is a polyamide, for example, the polyamide 6.6.

For the purposes of increasing the mechanical stability of the manufactured base body of the oil pan, provision may be made for the starting material being introduced into the cavity to comprise fibres, in particular, glass fibres.

In this case, the introduction of the starting material into the injection mould is preferably effected in such a manner that the preferred direction of the fibres in a flange region of the injection mould in which a mounting flange of the base body is to be formed is substantially parallel to a longitudinal direction of the base body.

In particular, the effect can thereby be achieved that the fibres in the mounting flange of the base body are substantially in parallel alignment with the longitudinal direction of the base body. Particularly high mechanical stability of the mounting flange is thereby obtained.

The further object of the present invention is to provide a base body of an oil pan which is mechanically highly stable as well as being particularly true to form.

In accordance with the invention, this object is achieved by a base body of an oil pan which is manufactured by a method in accordance with the invention.

In a preferred embodiment of such a base body, provision is made for the base body to be comprised of a fibre-reinforced synthetic material, and preferably to be formed substantially entirely from a fibre-reinforced synthetic material, and furthermore for it to comprise a mounting flange in which the preferred direction of the fibres is substantially parallel to a longitudinal direction of the base body.

Further features and advantages of the invention form the subject matter of the following description and the graphical illustration of exemplary embodiments.

### BRIEF DESCRIPTION OF THE DRAWINGS

FIG. 1 shows a perspective illustration of a base body of an oil pan which comprises a front deep region and a rear flat region, wherein the flat region extends away from the deep region in a longitudinal direction of the base body of the oil pan, in the form of a view of the upper end of the oil pan which faces the engine block when in the mounted state;

FIG. 2 a further perspective illustration of the base body of the oil pan depicted in FIG. 1, in the form of a view of the lower surface of the oil pan which is remote from the engine block in the mounted state of the oil pan;

FIG. 3 a side view of the base body of the oil pan depicted in FIGS. 1 and 2, as seen from the left;

FIG. 4 a plan view from above of the base body of the oil pan depicted in FIGS. 1 to 3, as seen in the direction of the arrow 4 in FIG. 3;

FIG. 5 a plan view from below of the base body of the oil pan depicted in FIGS. 1 to 4, as seen in the direction of the arrow 5 in FIG. 3;

FIG. 6 a front view of the base body of the oil pan depicted in FIGS. 1 to 5, as seen in the direction of the arrow 6 in FIG. 3;

FIG. 7 a perspective, part-sectional illustration of the flat region of the base body of the oil pan depicted in FIGS. 1 to 6, as seen when viewing the lower surface of the oil pan;

FIG. 8 a perspective, part-sectional illustration of the flat region of the base body of the oil pan depicted in FIG. 7, as seen when viewing the upper end of the oil pan;

FIG. 9 a vertical section through the flat region of the base body of the oil pan depicted in FIGS. 1 to 8, along the line 9-9 in FIG. 4;

FIG. 10 a vertical section through the deep region of the base body of the oil pan depicted in FIGS. 1 to 9, along the line 10-10 in FIG. 4;

FIG. 11 a perspective, part-sectional view of the deep region of the base body of the oil pan depicted in FIGS. 1 to 10, as seen when viewing the upper end of the oil pan;

FIG. 12 a perspective, part-sectional view of the deep region of the base body of the oil pan depicted in FIGS. 1 to 11, as seen when viewing the lower surface of the oil pan;

FIG. 13 a perspective, part-sectional view of the deep region of the base body of the oil pan depicted in FIGS. 1 to 12, as seen when viewing the upper end of the oil pan, wherein the sectional plane through the deep region of the base body runs in parallel with the sectional plane depicted in FIG. 11 and is closer to a front end of the base body;

FIG. 14 a perspective illustration of the right-hand half of the base body of the oil pan depicted in FIGS. 1 to 13, as seen when viewing the lower surface of the oil pan;

FIG. 15 an enlarged illustration of the deep region of the base body of the oil pan depicted in FIG. 14;

FIG. 16 a perspective plan view of an oil drainage opening of the oil pan, as seen when viewing the lower surface of the oil pan;

FIG. 17 a plan view from below of the oil drainage opening of the oil pan depicted in FIG. 16;

FIG. 18 a perspective illustration of a seating for a closure element for closing the oil drainage opening of the oil pan, as seen when viewing the upper end of the oil pan;

FIG. 19 a plan view from above of the seating for the closure element of the oil drainage opening depicted in FIG. 18;

FIG. 20 a perspective illustration of a closure element for closing the oil drainage opening of the oil pan, as seen when viewing a lower header part of the closure element;

FIG. 21 a side view of the closure element depicted in FIG. 20;

FIG. 22 a developed view of an upper guidance contour of a guidance channel of the closure element depicted in FIGS. 20 and 21 which is provided with exemplary dimensions;

FIG. 23 a perspective illustration of the seating for the closure element corresponding to FIG. 18, wherein the closure element is accommodated in the seating in a closing position;

FIG. 24 a plan view from below of the oil drainage opening of the oil pan corresponding to FIG. 17, wherein the oil drainage opening is closed by the closure element in the closing position;

FIG. 25 a vertical section through the oil drainage opening of the oil pan, the seating for the closure element and the closure element when accommodated in the seating in its closing position wherein it closes the oil drainage opening;

FIG. 26 a vertical section through the deep region of the base body of the oil pan and an oil suction pipe latched to the base body of the oil pan;

FIG. 27 an enlarged illustration of the region I depicted in FIG. 26;

FIG. 28 a perspective illustration of a seating for the oil suction pipe which is formed in one piece manner with the base body of the oil pan and a section of the oil suction pipe arranged outside the base body of the oil pan when in the mounted state;

FIG. 29 a schematic perspective illustration of the base body of the oil pan and a plurality of successively opened nozzles for the insertion of the starting material for the purposes of manufacturing the base body in a cascade injection moulding process; and

FIG. 30 a schematic vertical section through the flat region of an alternative embodiment of a base body of the oil pan along the line 9-9 in FIG. 4, wherein an off-set base section of the flat region of the base body is not off-set upwardly, but rather, downwardly.

Similar or functionally equivalent elements are designated by the same reference symbols in each of the Figures.

### DETAILED DESCRIPTION OF THE INVENTION

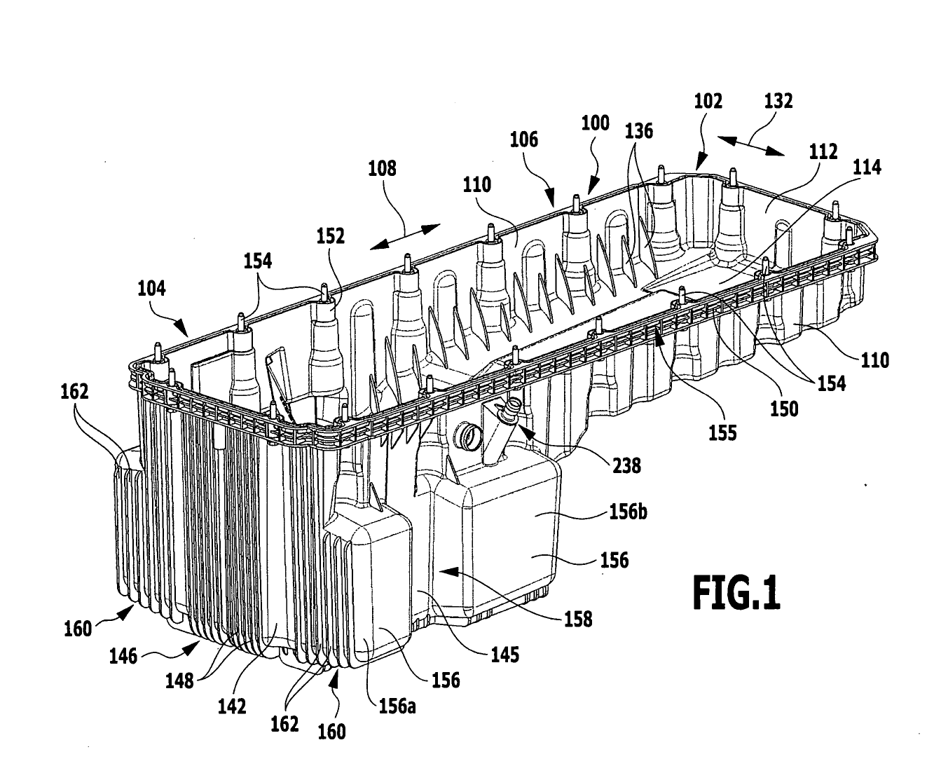

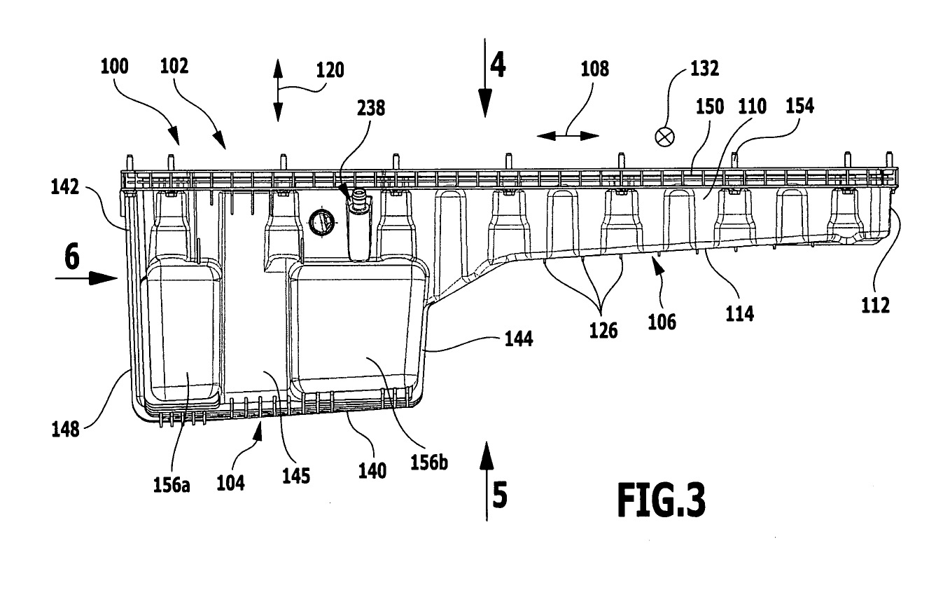

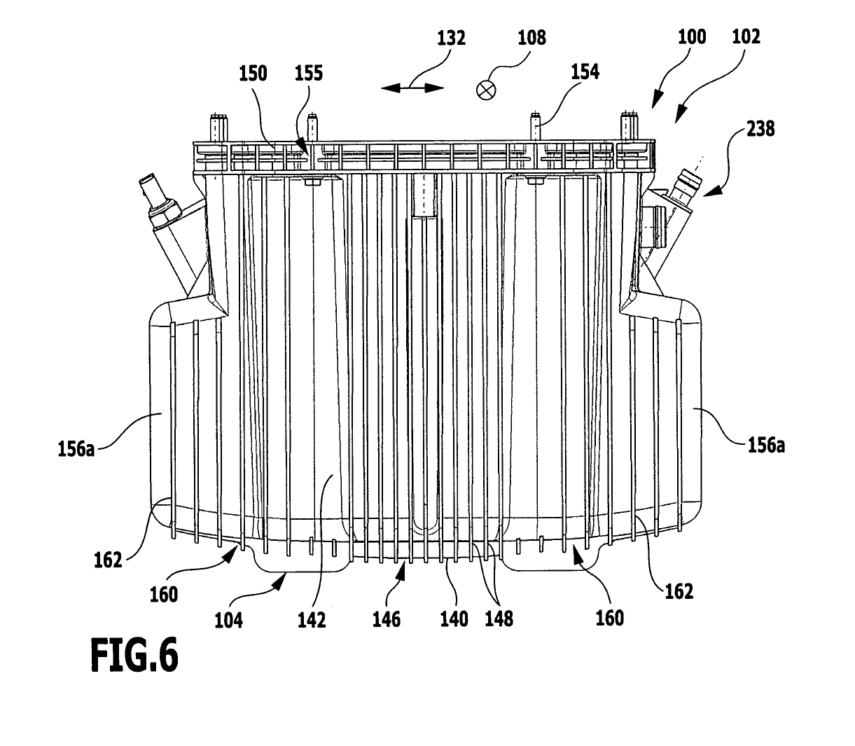

An oil pan which bears the general reference 100 and is illustrated in FIGS. 1 to 6 comprises a trough-shaped base body 102 which comprises a front deep region 104 and a rear flat region 106, wherein the flat region 106 extends away from the deep region 104 in the longitudinal direction 108 of the oil pan 100 and the base body 102.

The flat region 106 of the base body 102 has mutually opposed side walls 110 which extend in the longitudinal direction 108 and are connected to one another by a rear wall 112 at a rear end of the base body 102 remote from the deep region 104, and it also has a base 114 which interconnects the two side walls 110.

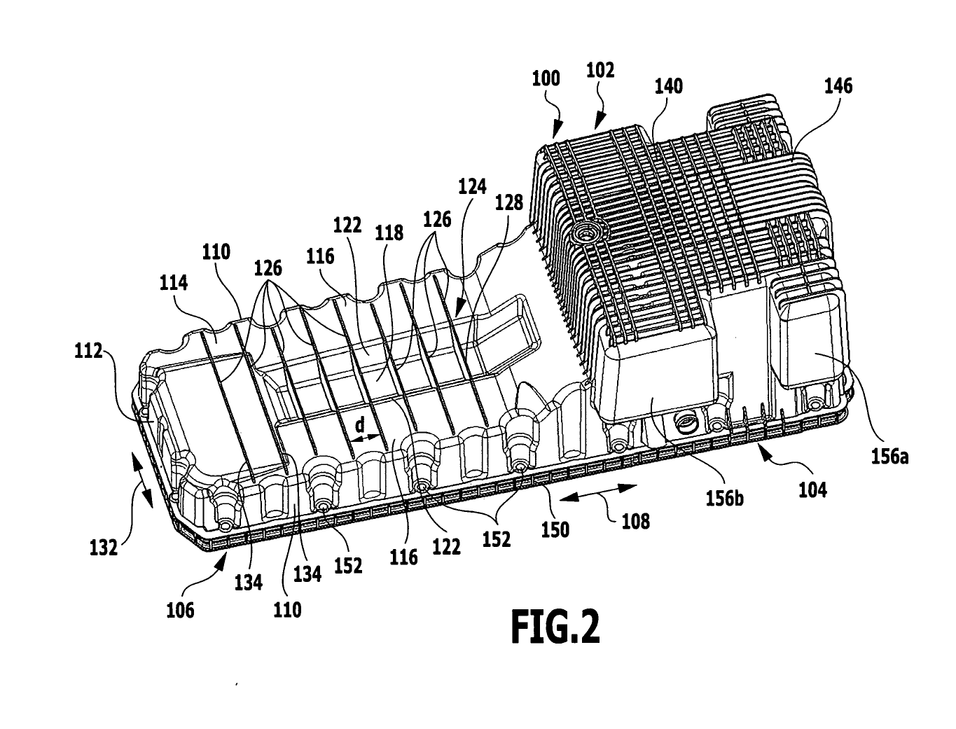

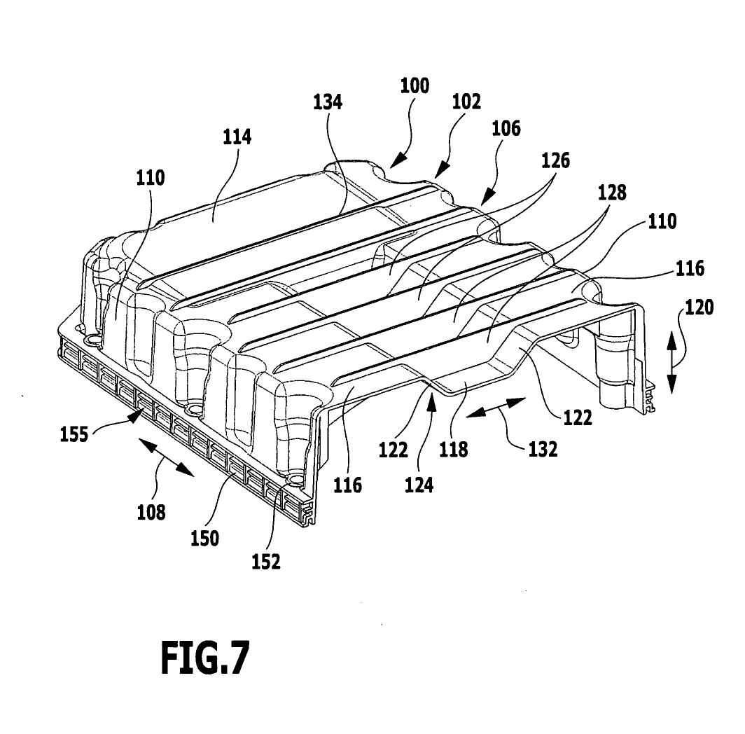

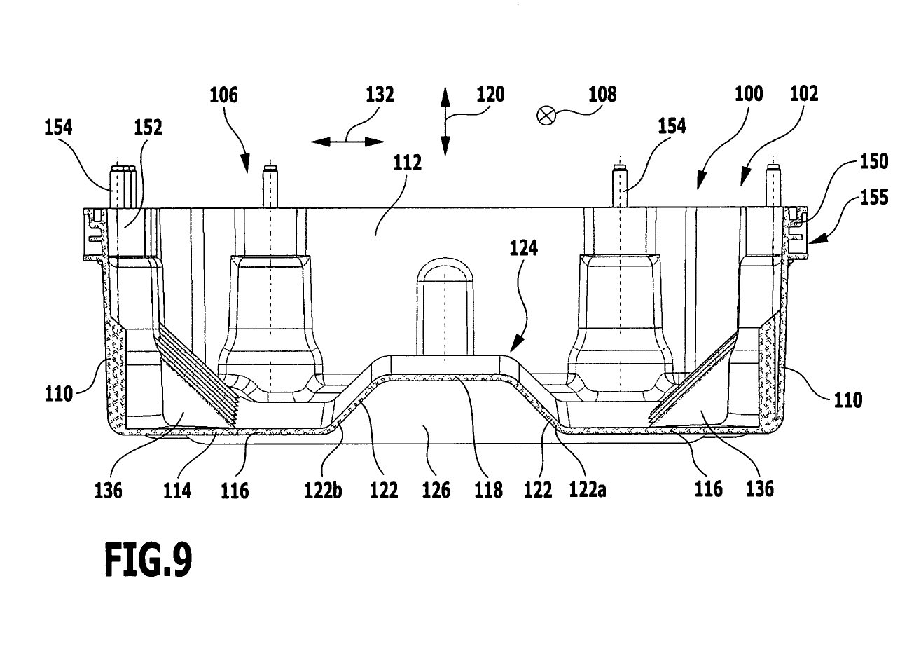

As can best be seen from FIGS. 2 and 7 to 9, the base 114 of the flat region 106 comprises two lateral base sections 116 each of which adjoins a respective side wall 110 and is oriented almost horizontally but with a slight inclination towards the deep region 104 of the base body 102 in the mounted state of the oil pan 100, said base also including an off-set base section 118 which is arranged between the lateral base sections 116 and is off-set upwardly with respect to the lateral base sections 116 into the interior of the flat region 106 of the base body 102, in the direction of the vertical 120 in the installed state of the oil pan 100.

In the installed state of the oil pan 100, the off-set base section 118 is also oriented almost horizontally with a slight inclination towards the deep region 104 of the base body 102 of the oil pan 100.

The off-set base section 118 is connected to each of the lateral base sections 116 by a connecting section 122 of the base 114 which is inclined to the horizontal in the installed state of the oil pan 100.

The off-set base section 118 together with the two adjoining connecting sections 122 are in the form of a bulge 124 which is formed in the base 114 of the flat region 106 of the base body 102.

For the purposes of reinforcing the bulge 124 and thus the base 114, provision is made for a plurality of coupling elements 126 which take the form of transverse ribs 128 that extend transversely, preferably substantially perpendicularly, to the longitudinal direction 108 of the base body 102 and the bulge 124 from the left-hand connecting section 122a over the off-set base section 118 up to the right-hand connecting section 122b and preferably moreover, over the respective lateral base section 116 up to at least close proximity to the respective side wall 110, and preferably up to the respective side wall 110 itself.

Together, these transverse ribs 128 form a transverse belt 130 which extends over at least most of the entire width of the base 114 of the flat region 106, or preferably over the entire width and thereby couples the two side walls 110 to one another and to the connecting sections 122 forming the side walls of the bulge 124.

The coupling elements 126 are preferably formed in one piece manner with the base 114 and the side walls 110 of the base body 102 of the oil pan 100.

Transverse bracing of the flat region 106 of the base body 102 of the oil pan 100 is obtained by virtue of the mechanical coupling of the side walls 110 and the connecting sections 122, whereby the resonant frequencies of the flat region 106 of the base body 102 are shifted to higher frequencies.

Furthermore, due to the presence of the bulge 124 in the otherwise substantially flat base 114 of the flat region 106, the effect is achieved that the lowest natural oscillation of this region of the base body 102 has an amplitude that lies in the transverse direction 132 of the base body 102 of the oil pan 100 which extends substantially perpendicularly with respect to the longitudinal direction 108 and perpendicularly with respect to the vertical 120.

Due to these measures, the effect is achieved that, in operation of the engine on which the oil pan 100 is mounted, the oil pan 100 is only excited into natural oscillation to a very limited extent by vibrations of the engine so that production of noise is minimized by an acoustic optimisation process and in addition, the mechanical stability of the oil pan is not impaired by vibrations of the base body 102.

As can best be seen from FIG. 2, the bulge 124 incorporating the off-set base section 118 extends in the longitudinal direction 108 over more than half, and preferably over at least two thirds, of the length of the flat region 106 of the base body 102, i.e. the extent thereof in the longitudinal direction 108.

The bulge 124 extends forwardly to almost as far as the deep region 104 of the base body 102.

In the rearward direction, the bulge 124 ends at some distance from the rear wall 112.

The transverse belt 130 formed by the coupling elements 126 extends over more than half, preferably over more than two thirds, of the length of the bulge 124 in the longitudinal direction 108.

Furthermore, provision may be made for the transverse belt 130 to comprise additional transverse ribs 134 which are arranged between the rear end of the bulge 124 and the rear wall 112.

All of the coupling elements 126 and the additional transverse ribs 134 are formed such as to be narrow in the longitudinal direction 108 and the thickness thereof in this direction is significantly smaller than the spacing d of the coupling elements 126 following one another in the longitudinal direction 108.

Preferably, the thickness is less than half, and in particular less than a quarter of the spacing d in the longitudinal direction 108.

All of the coupling elements 126 are substantially parallel to each other and aligned with respect to the transverse direction 132 and follow one another in the longitudinal direction 108 such that they are substantially equidistant.

The coupling elements 126 and the additional transverse ribs 134 are preferably provided exclusively on the exterior of the base body 102 and project downwardly from the exterior of the base 114.

Coupling elements 126 are preferably not provided in the interior of the flat region 106 of the base body 102 in order not to obstruct the flow of oil returning from the flat region 106 into the deep region 104 of the base body 102.

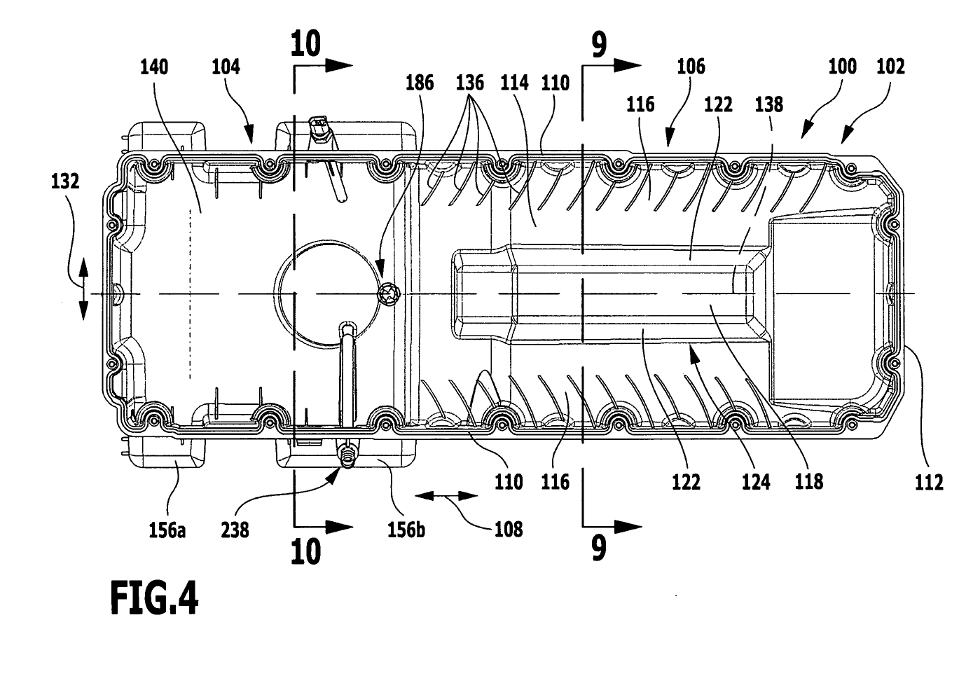

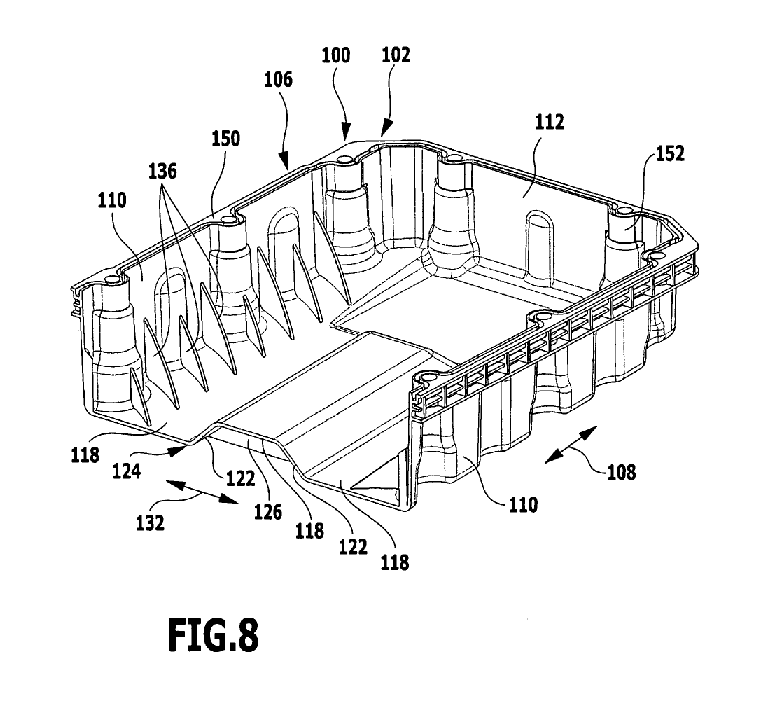

As can best be seen from FIGS. 4 and 8, the flat region 106 of the base body 102 has internal ribs 136 which provide further reinforcement and are substantially triangular as seen in the side view, said ribs each connecting a respective side wall 110 to the neighbouring lateral base section 116.

In order to facilitate the discharge of oil from the gaps between the internal ribs 136, the internal ribs 136 are oriented at an angle to the longitudinal direction 108 of the base body 102, namely, in such a manner that the ends thereof remote from the respective side wall 110 are closer to the deep region 104 of the base body 102 than the ends thereof facing the respective side wall 110.

Furthermore, the internal ribs 136 are preferably curved, namely, curved concavely as seen from the deep region 104 of the base body 102.

Due to this concave curvature, remnants of oil are prevented from remaining behind the internal ribs 136 when the oil is flowing away from the flat region 106 of the base body 102.

The number of internal ribs 136 is preferably approximately twice as large as the number of transverse ribs 128 and 134 on the exterior of the flat region 106.

The point of coupling of each second internal rib 136 to the respectively associated side wall 110 is preferably located at approximately the same axial position (along the longitudinal direction 108) as the point of coupling of one of the transverse ribs 128 or 134 to the same side wall 110, whereby the coupling of the particular transverse rib 128 or 134 to the respective side wall 110 is strengthened.

The off-set base section 118 and preferably the entire bulge 124 are formed such as to be substantially mirror-symmetrical with respect to a longitudinal centre plane 138 of the base body 102 running vertically in the longitudinal direction 108 of the base body 102 in the installed state of the oil pan 100.

The front deep region 104 of the base body 102 comprises a base 140, a front wall 142 which is remote from the flat region 106 of the oil pan 100, a rear wall 144 which connects the base 140 of the deep region 104 to the base 114 of the flat region 106 and two side walls 145 which connect the front wall 142 to the rear wall 144 and extend substantially parallel to the longitudinal direction 108 (see in particular FIGS. 1 to 6).

For the purposes of reinforcing the deep region 104, it is provided on its outer surface with a central longitudinal belt 146 which comprises a plurality of mutually parallel longitudinal ribs 148 that are spaced from each other in the transverse direction 132 of the base body 102 and extend substantially vertically downwardly from a mounting flange 150 at the upper edge of the front wall 142 over the front wall 142 and then over the base 140 of the deep region 104 up to the rear wall 144 of the deep region 104.

Within the area of the base 140, the longitudinal ribs 148 run substantially parallel to the longitudinal direction 108 of the base body 102.

The mounting flange 150 serves for mounting the base body 102 of the oil pan 100 (by means of a not illustrated seal) on the engine block of a (not illustrated) internal combustion engine and runs in a closed ring around the upper edge of the deep region 104 and the flat region 106 of the base body 102.

The mounting flange 150 has a plurality of seatings 152 which are spaced from each other around the periphery of the mounting flange 150 and serve to accommodate fixing bolts 154 with the aid of which the oil pan 100 is arranged to be fixed to the engine block.

For the purposes of reinforcing the mounting flange 150, it is provided around its periphery with boxed ribbing 155.

The deep region 104 of the base body 102 comprises auxiliary compartments 156 which protrude out from the side walls 145 in the transverse direction 132, the interiors of said compartments communicating with the interior of the deep region 104 and increasing its oil storage capacity.

In particular, on each side wall 145, there are provided a smaller front auxiliary compartment 156a and a larger rear auxiliary compartment 156b which are separated from each other by a gap 158 which serves for accommodating mounting struts for the engine during the process of mounting the oil pan 100 on the engine.

In addition to the central longitudinal belt 146, provision is also made for lateral longitudinal belts 160 each of which comprises a plurality of longitudinal ribs 148 which extend from the mounting flange 150 over the front wall 142 and the base 140 of the deep region 104 up to the rear wall 144 thereof.

Additional lateral longitudinal ribs 162 may extend over the front surface of the front auxiliary compartments 156a and also over the lower surfaces of the front auxiliary compartments 156a and the rear auxiliary compartments 156b, each of these ribs being interrupted by one of the gaps 158.

The longitudinal ribs 148 of the central longitudinal belt 146 and those of the lateral longitudinal belts 160 preferably extend over the entire rear wall 144 of the deep region 104 up to the beginning of the base 114 of the flat region 106.

The base 114 of the flat region 106 can be inclined to the horizontal at a relatively large angle of e.g. approximately 30° at the end thereof facing the deep region 104 in order to promote the discharge of oil from the flat region 106 into the deep region 104.

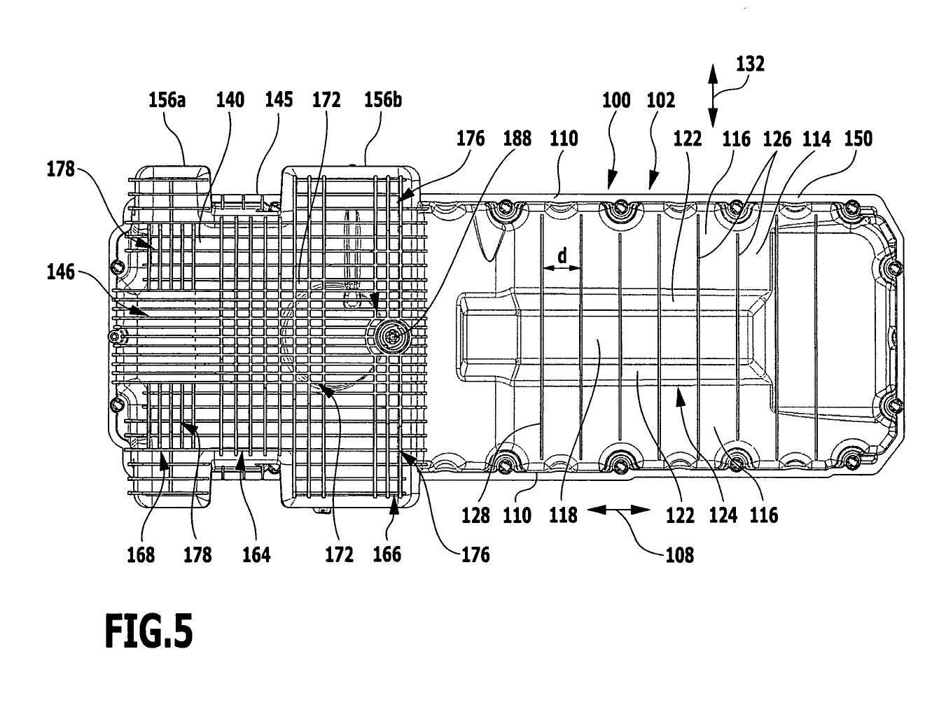

As can best be seen from FIGS. 2 and 5, in addition to the longitudinal ribs 148 and 162, the base 140 of the deep region 104 is provided with a central transverse belt 164, a rear transverse belt 166 and a front transverse belt 168, each of these belts being formed from a plurality of transverse ribs 170 that extend in the transverse direction 132 and are spaced from one another in the longitudinal direction 108.

The transverse ribs 170 of the central transverse belt 164 cross the longitudinal ribs 148 of the central longitudinal belt 146 at an approximately square-shaped central section 172 of the base 140 where they form a cross-ribbed pattern.

The transverse ribs 170 of the central transverse belt 166 each extend over the entire width of the base 140 (including the lower surfaces of the auxiliary compartments 156), i.e. over its entire extent in the transverse direction 132 so that the side walls 110 of the deep region 104 of the base body 102 are coupled to one another by means of the central transverse belt 164.

Due to the mechanical coupling of the rear wall 144 of the deep region 104 by means of the central longitudinal belt 146 to the front wall 142 and the mounting flange 150 on the one hand, and the mechanical coupling of the two side walls 145 of the deep region 104 by means of the central transverse belt 164 on the other, the deep region 104 is reinforced in such a way that its resonant frequencies are shifted to higher frequencies.

This has the consequence that in operation of the combustion engine, a lesser degree of natural oscillation of the oil pan 100 will be induced by vibrations of the engine, this thereby resulting in the development of less noise due to acoustic optimisation as well as greater mechanical stability of the oil pan 100.

The transverse ribs 170 of the rear transverse belt 166 are curved in the central region thereof between the side walls 145 and surround an oil drainage opening 174 of the base body 102 that is provided in the base 140 of the deep region 104.

On the left and on the right of the oil drainage opening 174, the transverse ribs 170 of the rear transverse belt 166 are crossed by the longitudinal ribs 148 of the central longitudinal belt 146 and those of a respective lateral longitudinal belt 160 as well as by the additional lateral longitudinal ribs 162 on the auxiliary compartments 156 so that, to the left and the right of the oil drainage opening 174, there is formed a rear support zone 176 incorporating cross ribbing on which the unit consisting of the engine block and the oil pan 100 mounted thereon can be set down.

In like manner, the transverse ribs 170 of the front transverse belt 168, which are interrupted in the vicinity of the central longitudinal belt 146, cross the longitudinal ribs 148 of the lateral longitudinal belts 160 and thus form additional front support zones 178 on both sides of the central longitudinal belt 146, each of which zones incorporates crossed ribbing and can likewise serve for setting down the unit consisting of the engine block and the oil pan 100 mounted thereon.

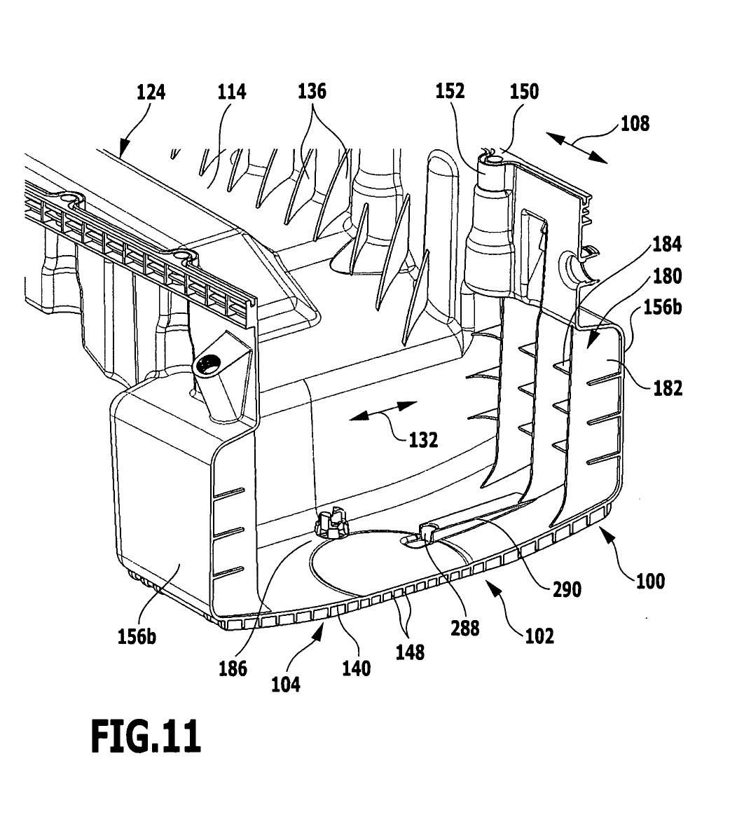

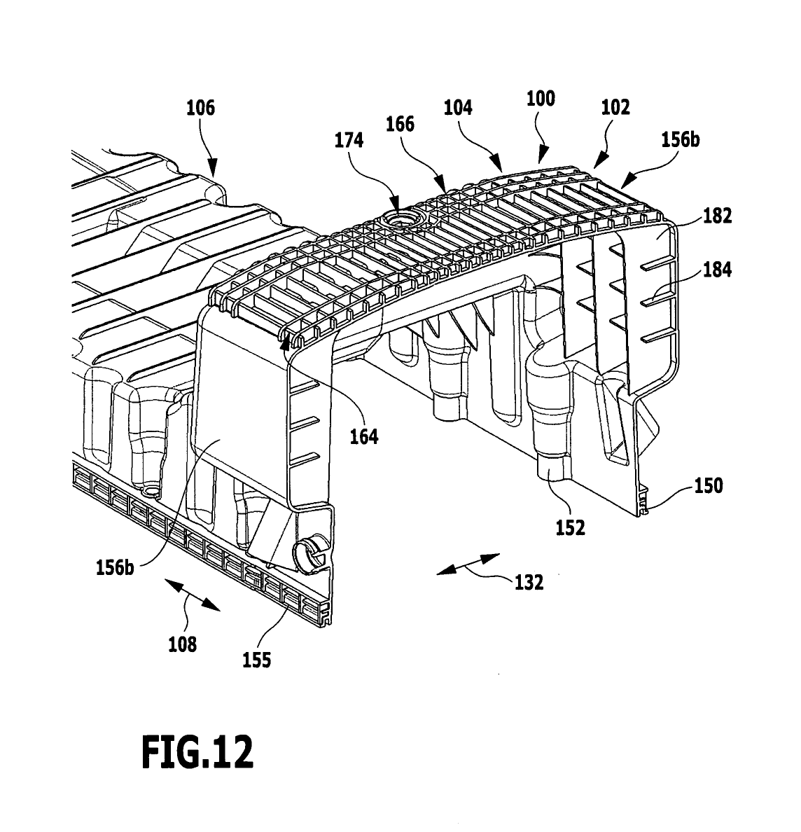

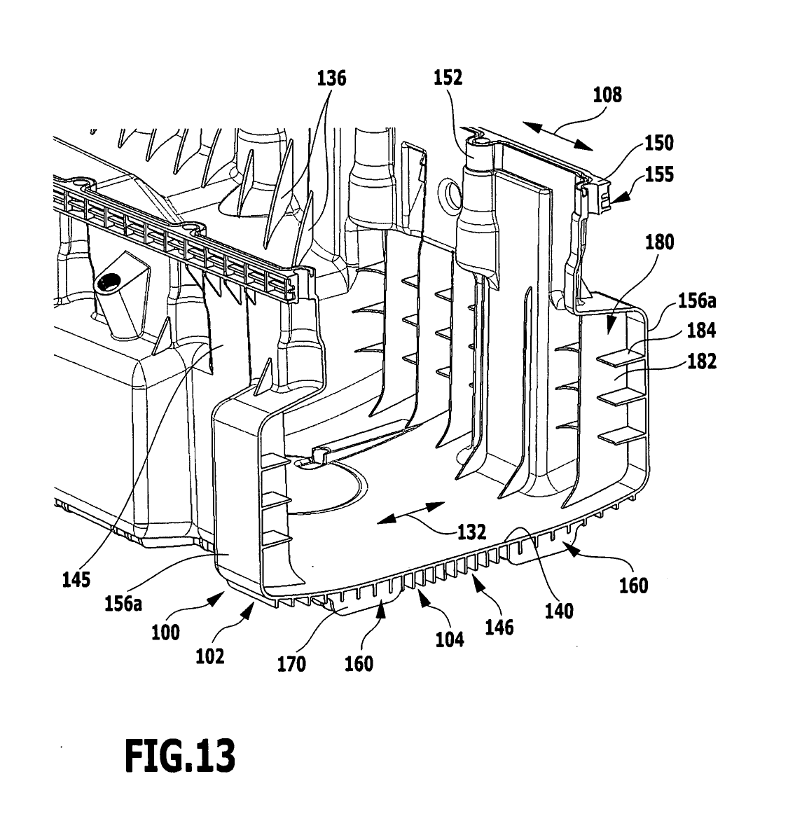

As can best be seen from FIGS. 11 to 13, the inner surfaces of the auxiliary compartments 156 of the deep region 104 of the base body 102 are provided with a crossed ribbing 180 consisting of internal vertical ribs 182 running in a substantially vertical direction and horizontal ribs 184 which cross the vertical ones and extend substantially horizontally in the installed state of the oil pan 100, this thereby further reinforcing the deep region 104 of the base body 102.

The vertical ribs 182 preferably project into the interior of the deep region 104 to a greater extent than the horizontal ribs 184.

On the outer surface of the deep region 104, the longitudinal ribs 148 and 162 preferably project above the outer surface of the base body 102 to a greater extent than the transverse ribs 170, since stones hurled up from the road after the oil pan 100 and the engine block have been installed into a motor vehicle tend to be moving more often in the longitudinal direction 108 than in the transverse direction thereto.

The longitudinal ribs 148 and 162 on the front wall 142 of the base body 102 serve as a protection against stone impacts in addition to achieving a mechanical coupling to the mounting flange 150.

The base 140 of the deep region 104 of the base body 102—as seen from the exterior of the oil pan 100—preferably has a convex curvature.

The oil drainage opening 174 is preferably arranged at the lowermost point of the base 140 of the base body 102 when the oil pan 100 is in its installed state.

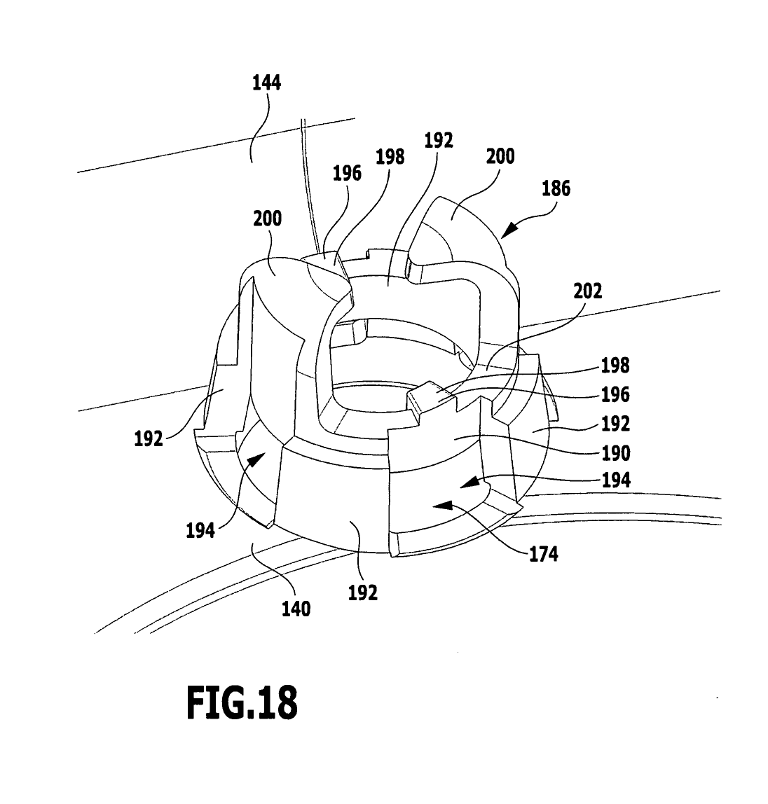

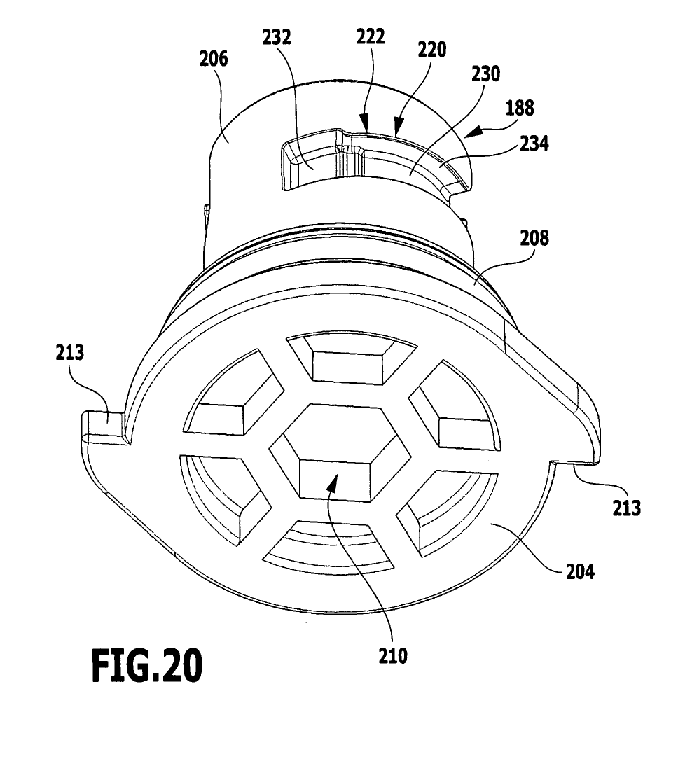

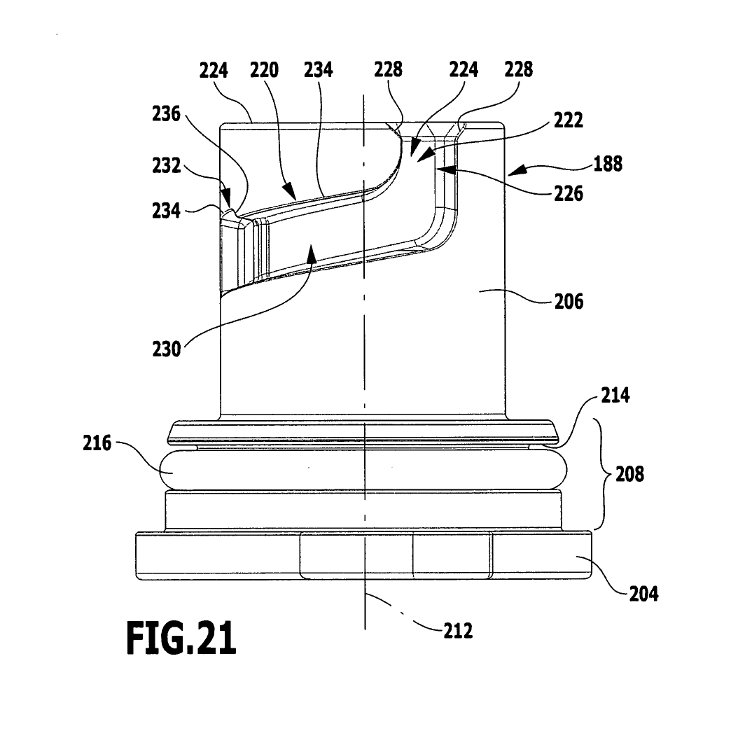

As can best be seen from the perspective illustration of FIG. 18, on the inside of the deep region 104 of the base body 102 and surrounding the oil drainage opening 174, provision is made for a seating 186 for a closure element 188 which is used to close the oil drainage opening 174 and is illustrated separately in FIGS. 20 and 21.

The seating 186 comprises an annular carrier 190 which is supported by a plurality of e.g. four supports 192 that project upwardly into the interior of the deep region 104 from the base 140 of the deep region 104 of the base body 102.

Through openings 194, which extend downwardly to at least the upper surface of the base 140, are formed between the supports 192 so that oil from the interior of the base body 102 can flow off in its entirety through these openings 194 into the oil drainage opening 174 whereby the interior of the base body 102 can be substantially completely emptied of oil.

Two seating-side guide elements 196 in the form of guidance projections 198 respectively located in the area between two supports 192 project radially from the annular carrier 190 (taken with reference to the central axis of the oil drainage opening 174) into the interior of the annular carrier 190.

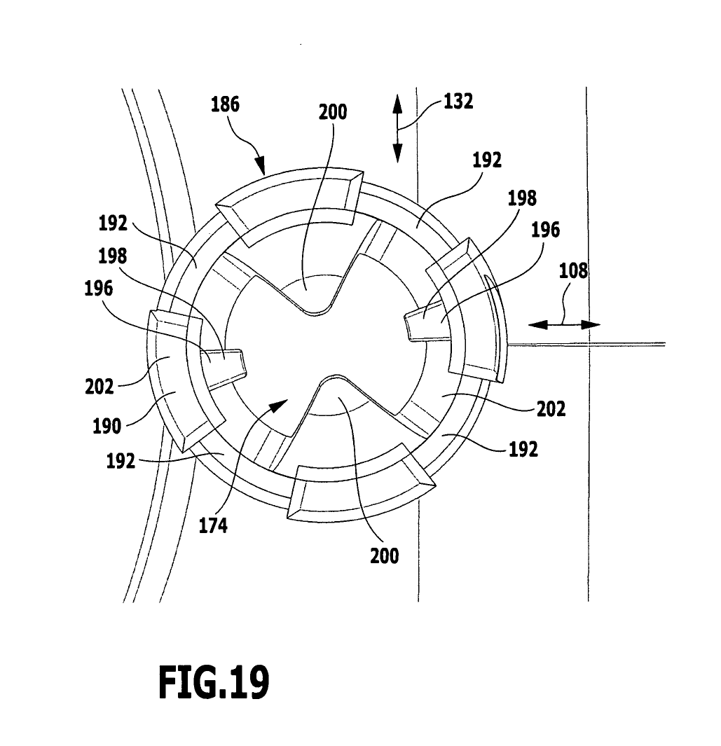

As can best be seen from FIG. 19, the two seating-side guide elements 196 are substantially diametrically opposite.

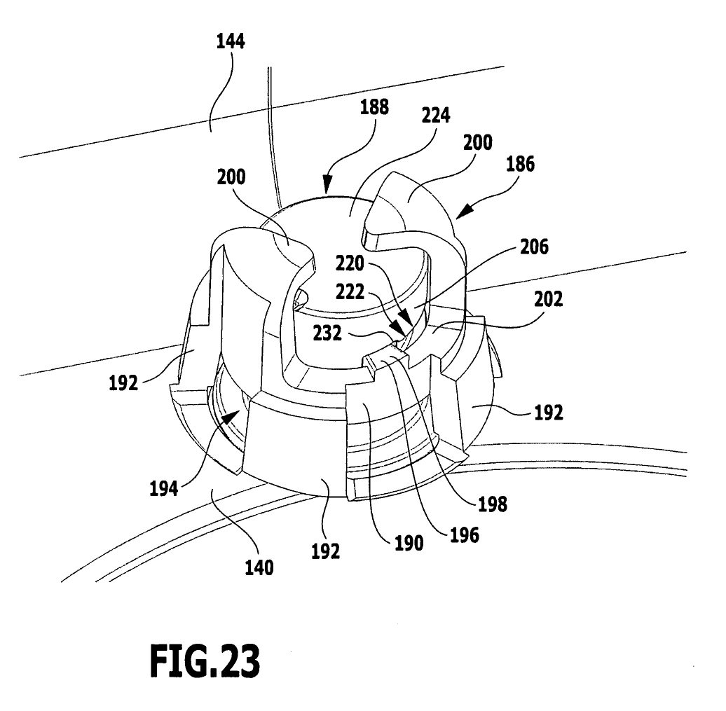

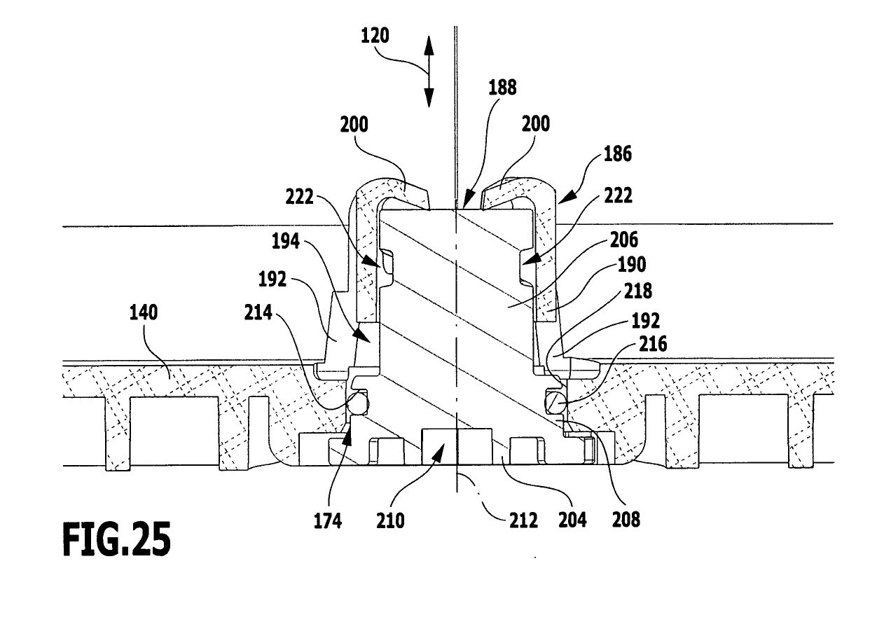

Arranged between the two seating-side guide elements 196 around the periphery of the annular carrier 190 and angularly spaced from the seating-side guide elements 196 by approximately 90°, there are two hook-shaped spring elements 200 which extend upwardly from the upper surface 202 of the annular carrier 190 and, as illustrated in FIGS. 23 and 25, overlap the closure element 188 in its closing position.

The previously described seating 186 for the closure element 188 is preferably formed in one piece manner and in particular, is formed in one piece manner with the base body 102 of the oil pan 100.

As can best be seen from FIGS. 20 and 21, the closure element 188 comprises a lower head section 204, an upper substantially cylindrical guidance section 206 and a sealing section 208 which connects the guidance section 206 to the head section 204.

The head section 204 serves as the means for actuating the closure element 188 and, for this purpose, it comprises a central, engagement opening 210 in which an operating tool can engage in order to rotate the closure element 188 about its longitudinal axis 212.

This engagement opening 210 may, for example, be in the form of a polygon for enabling it to co-operate with an operating tool having a complementary polygonal cross section.

Moreover, the head section 204 is provided on its periphery with two stop members 213 which stop the rotational movement of the closure element 188 when the closing position of the closure element 188 is reached in order to prevent the closure element from being over tightened.

The sealing section 208 incorporates a peripherally extending annular groove 214 in which a sealing ring 216 consisting preferably of an elastomeric material is accommodated.

In the closing position of the closure element 188 that is shown in the form of a vertical cross section in FIG. 25, the sealing ring 216 abuts a peripheral wall 218 of the oil drainage opening 174 in sealing manner so as to prevent the oil from draining out of the oil pan 100 when the closure element 188 is in its closing position.

The guidance section 206 of the closure element 188 comprises two closure-element-side guide elements 220 each of which is in the form of a guide channel 222 in which a respective one of the seating-side guide elements 196 in the form of a guidance projection 198 can engage.

Each guide channel 222 comprises an insertion section 226 which opens out into an upper end face 224 of the closure element 188 and extends downwardly from the outer edge of the end face 224 substantially parallel to the longitudinal axis 212 of the closure element 188.

In order to facilitate the process of inserting the seating-side guide element 196 into the guide channel 222, the upper end of this insertion section 226 is provided with bevelled inlets 228 which widen out the insertion section 226 towards the end face 224.

A spiral-like turning section 230 of the guide channel 222 adjoins the insertion section 226 of the guide channel 222. When the seating-side guide element 196 engages in this turning section 230 of the guide channel 222, the rotation of the closure element 188 about its longitudinal axis 212 simultaneously causes the closure element 188 to move along the longitudinal axis 212 upwardly relative to the seating 186 so that the sealing section 208 of the closure element 188 is pulled into the oil drainage opening 174 and the sealing ring 216 comes to engage the peripheral wall 218 of the oil drainage opening 174.

At the lower end of the turning section 230 of the guide channel 222, there is an adjoining latching section 232, in which the upper edge 234 of the guide channel 222 is displaced upwardly in the direction of the longitudinal axis 212 of the closure element 188 by the height of a step 236 with respect to the upper edge 234 at the lower end of the turning section 230 so that, when the closure element 188 has been rotated sufficiently for the seating-side guide element 196 to reach the latching section 232 of the guide channel 222, said closure element 188 will be moved slightly downwardly along the longitudinal axis 212 by virtue of the resilient biasing force exerted by the spring elements 200 of the seating 186 on the end face 224 of the closure element 188 whereby the seating-side guide element 196 latches in the latching section of the guide channel 222 and is prevented from returning to the turning section 230 of the guide channel 222 by the step 236 at the upper edge 234 of the guide channel 222.

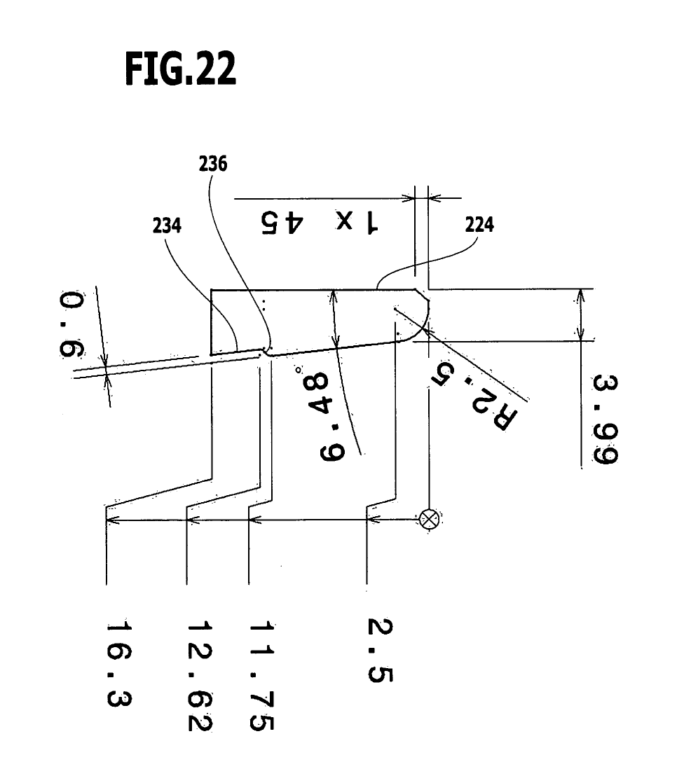

A developed view of the upper edge 234 of the guide channel 222 of the closure element 188 is illustrated in the form of a concrete embodiment with exemplary dimensioning (in millimetres) in FIG. 22.

From this, it is apparent that the inclination of the turning section 230 of the guide channel 222 relative to the upper end face 224 of the closure element 188 can amount to approximately 6.5° for example.

The height of the step (measured vertically relative to the upper edge 234 of the guide channel 222) can amount to approximately 0.6 mm for example.

The two guide channels 222 of the closure element 188 are formed such as to be identical to one another and they are mutually off-set in the peripheral direction of the closure element 188 by an angle of 180°.

When inserting the closure element 188 into the oil drainage opening 174, the seating-side guide elements 196 of the seating 186 enter the respectively associated guide channel 222 through the insertion sections 226. By pressing the closure element 188 into the oil drainage opening 174 along the longitudinal axis 212, the seating-side guide elements 196 then reach the turning section 230 of the respectively associated guide channel 222 through the insertion section 226.

By a subsequent rotation of the closure element 188 by means of an operating tool engaging in the engagement opening 210 of the head section 204 through an angle of more than 90° for example, each seating-side guide element 196 passes through the turning section 230 of the respectively associated guide channel 222, whereby the closure element 188 is pulled further into the oil drainage opening 174 in order to seal it.

Finally, each seating-side guide element 196 reaches the respectively associated latching section 232 so that the closure element 188 is latched to the seating 186 in the closing position.

Due to the downwardly effective resilient bias force of the shaped, resilient spring elements 200 which are in contact with the upper end face 224 of the closure element 188, the closure element 188 is held in this closing position.

Thus, together, the closure element 188 and the seating 186 form a spring-loaded bayonet fixing for the oil drainage opening 174.

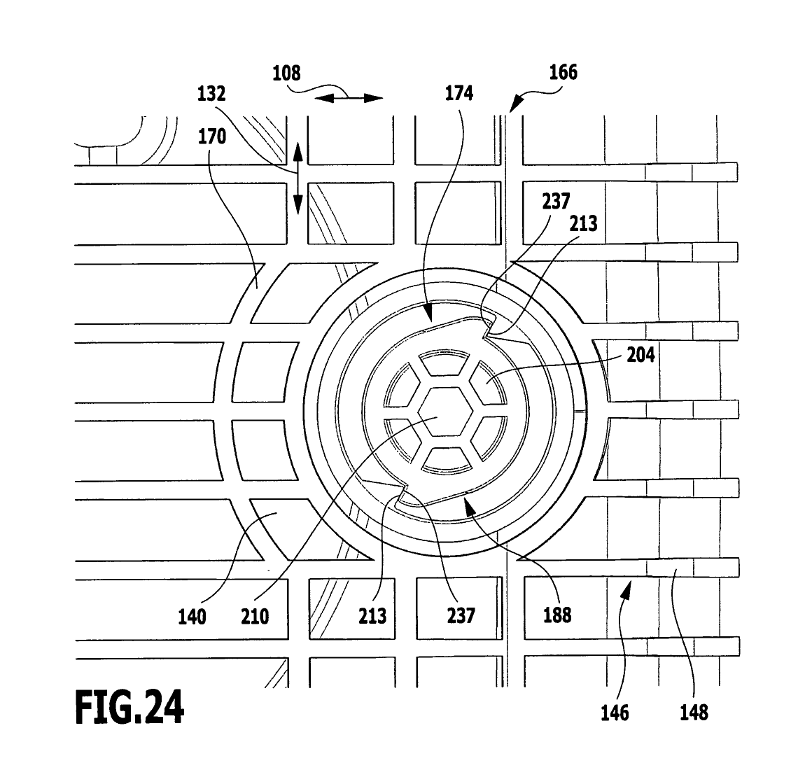

As can best be seen from FIG. 24 which shows the closure element 188 in its closing position, the stop members 213 of the head section 204 of the closure element 188 abut, in the closing position, a respectively associated counter-stop-member 237 that is arranged on the base body 102 of the oil pan 100 so that the closure element 188 cannot be turned relative to the seating 186 beyond the closing position whereby damage to the seating 186 and/or the closure element 188 due to such an excessive rotation of the closure element 188 is not possible.

In order to remove the closure element 188 from the oil drainage opening 174, this resilient biasing of the spring elements 200 must firstly be overcome by the application of a correspondingly large amount of torque so that the seating-side guide elements 196 can be moved relative to the guide channel 222 over the step 236 of the upper edge 234 of the guide channel 222 into the respective turning section 230 of the guide channel 222.

After overcoming this initial resistance which is effective to prevent the closure element 188 from being moved unintentionally out of the closing position, the seating-side guide elements 196 can be moved back into the insertion section 226 of the respective guide channel 222 by rotation of the closure element 188 about its longitudinal axis 212. A release position of the closure element 188 is thereby reached, wherein the closure element 188 is removable completely from the seating 186 and thus completely from the base body 102 of the oil pan 100 by withdrawing it downwardly from the seating 186 along the longitudinal axis 212.

In order to achieve the effect that the closure element 188 does not sink into the oil that has been drained off into an oil receptacle in the course of an oil change, but rather, floats thereon so that it can easily be removed from the discharged oil and the mechanic can let without regard the closure element 188 that has been released from the oil pan fall into the oil receptacle during an oil change, provision is preferably made for the closure element 188 to have an average specific gravity which is less than the specific gravity of the engine oil that is to be accommodated in the oil pan 100.

Since the specific gravity of the engine oils that are to be used in motor vehicles usually lies within a range of approximately 0.8 g/cm³ to approximately 0.95 g/cm³, the average specific gravity of the closure element 188 preferably amounts to at most approximately 0.7 g/cm³, and in particular to at most approximately 0.5 g/cm³.

In order to achieve the desired low average specific gravity of the closure element 188, provision may be made in particular for the interior of the closure element 188 to be in the form of a (not illustrated) cavity having a volume that is of such a size in relation to the total volume of the closure element 188 that, taking into consideration the specific gravity of the material used for the production of the closure element 188, the average specific gravity of the entire closure element 188 including the cavity will adopt the desired value so that the closure element 188 will float in the engine oil, but in particular, in such a manner that a considerable part of the closure element 188 will stand out from the engine oil.

In particular, such a closure element 188 can be in the form of an injection moulded part of synthetic material which is manufactured using the known gas internal pressure injection moulding process (GID).

In principle, gas internal pressure injection moulding is a normal injection moulding process but with the difference that, towards the end of the process of filling the moulding cavity of the injection mould, an inert gas (nitrogen for example) is injected under pressure into the moulding cavity. The gas thereby displaces the plastic melt and, due to the proportionately high gas pressure, causes the plastic melt to be pushed against the wall of the mould's moulding cavity where it forms a coating which is closed after the withdrawal of the injection needle used for the supply of the gas. Relatively thick-walled plastic parts containing cavities can be manufactured economically and with good surface quality by means of the gas internal pressure injection moulding process.

As an alternative thereto, the closure element 188 can be built up from two individual parts that have been manufactured in a simple conventional injection moulding process, these parts together enclosing the internal cavity of the closure element 188 therebetween and being connected to one another by adhesion or thermal welding for example.

As can best be seen from FIGS. 1 and 26 to 28, the oil pan 100 comprises an oil suction device 238 incorporating a lead-through 240 which is preferably arranged on one of the side walls 145 of the deep region 104 of the base body 102 and is formed in the base body 102 and also an oil suction pipe 242 which is manufactured separately from the base body 102 and extends through the lead-through 240 from an area 244 outside the base body 102 into the interior 246 thereof.

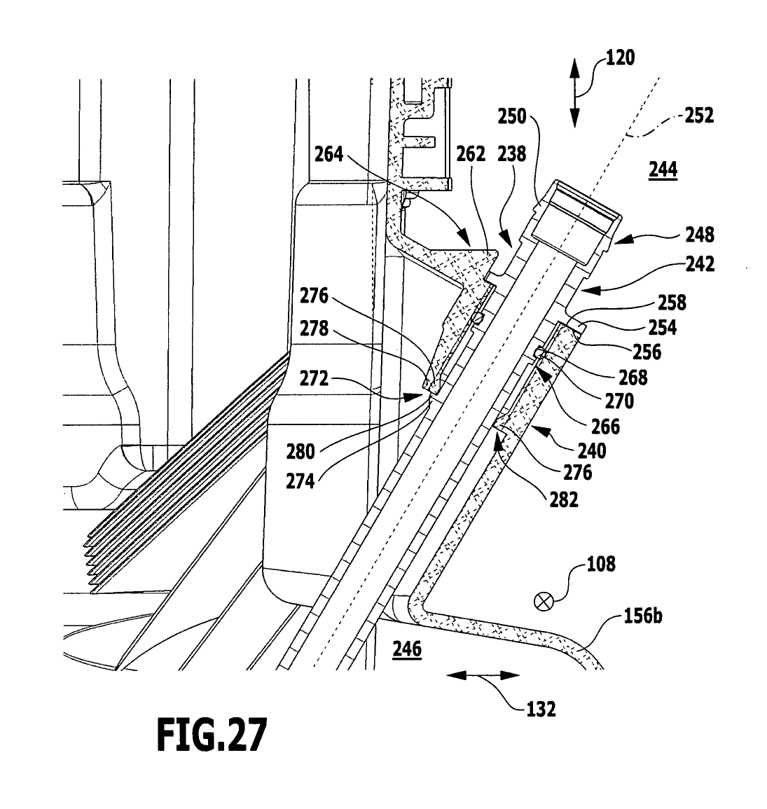

As can best be seen from FIG. 27, the upper end of the oil suction pipe 242 that is located in the outside area 244 is provided with a connecting piece 248 which has a downwardly widening conical connector profile 250 over which a (not illustrated) oil return pipe can be pushed onto the connecting piece 248 in order to connect the oil return line to the connecting piece 248 of the oil suction pipe 242 in force-locking and/or shape-locking manner.

As seen along the longitudinal axis 252 of the oil suction pipe 242, a support collar 254 is formed on the oil suction pipe 242 below the connecting piece 248, said support collar projecting radially outwardly relative to the longitudinal axis 252 whilst the lower surface 256 thereof rests substantially flat upon the upper end 258 of the lead-through 240 and thus supports the oil suction pipe 242 when in the mounted state.

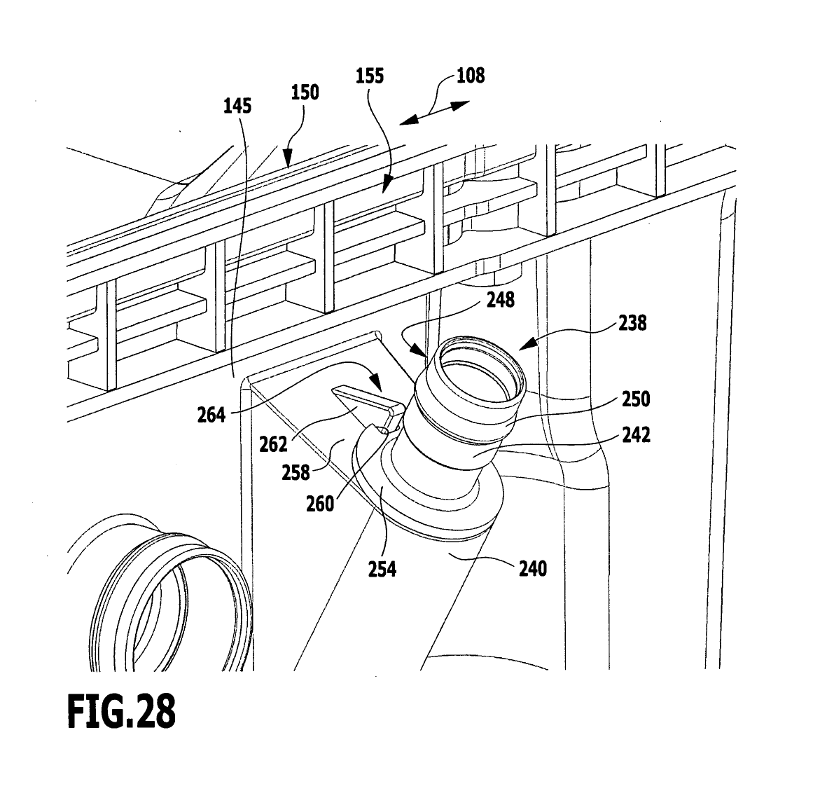

As can best be seen from FIG. 28, the support collar 254 is not rotationally symmetric; namely, at one point of its periphery, it includes a positioning recess 260 which is engaged in the mounted state of the oil suction pipe 242 by a complementary positioning projection 262 of the base body 102 so that the oil suction pipe 242 is held on the lead-through 240 in a manner such that it cannot rotate relative thereto.

Together, the positioning recess 260 of the oil suction pipe 242 and the positioning projection 262 of the base body 102 thus form an anti-twist arrangement 264 for the oil suction pipe 242.

Further along the longitudinal axis 252 in the downward direction, the support collar 254 of the oil suction pipe 242 is adjoined by a sealing section 266 which is provided with an annular groove 268 in which a sealing ring 270 is accommodated.

The sealing ring 270 is, for example, formed of an elastomeric material and abuts an internal peripheral surface of the lead-through 240 in sealing manner so that it is not possible for oil to escape from the interior 246 of the base body 102 through the lead-through 240.

The sealing section 266 of the oil suction pipe 242 is adjoined along the longitudinal axis 252 in the downward direction by a latching section 272 which is provided with a plurality of e.g. three latching projections 274 which are arranged such that they are angularly spaced from one another around the periphery of the oil suction pipe 242 and are directed outwardly in a direction that is radial to the longitudinal axis 252.

In the mounted state of the oil suction pipe 242, these latching projections 274 engage behind a respective resilient latching tongue 276 which is formed in one piece manner with the base body 102 of the oil pan 100.

During the process of inserting the oil suction pipe 242 through the lead-through 240, the latching tongues 276 yield in the radial direction in order to allow the latching projections 274 of the oil suction pipe 242 to pass.

Subsequently, the latching tongues 276 move back into their initial position due to the resilient nature thereof so that they then prevent a return movement of the latching projections 274 through the lead-through 240 and the oil suction pipe 242 is latched directly to the base body 102.

Thus, the latching tongues 276 form base-body-side latching elements 278 and the latching projections 274 form pipe-side latching elements 280 of a latching device bearing the general reference 282 by means of which the oil suction pipe 242 is adapted to be latched to the lead-through 240 of the base body 102.

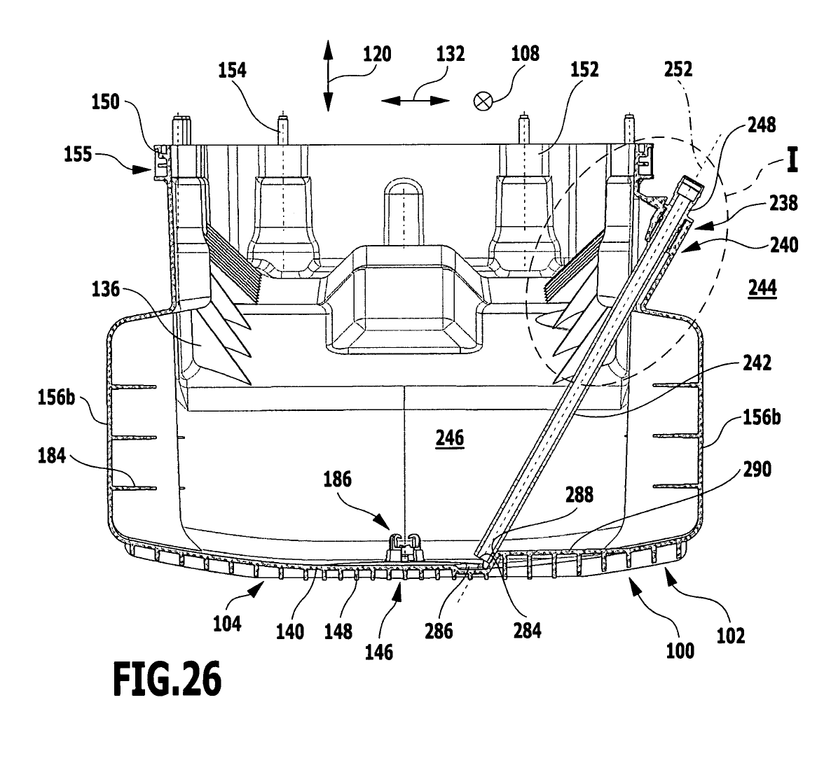

As can best be seen from FIG. 26, the lower end of the oil suction pipe 242 when in the mounted state, is supported on a preferably curved contact surface 284 which is formed on a rib 286 that is formed into the base 140 of the deep region 104 of the base body 102.

In the mounted state of the oil suction pipe 242, a section of the outer peripheral surface of the oil suction pipe 242 rests against a curved supporting surface 288 which is in the form of a peripheral section of a cylinder and is formed at an end region of a ramp 290 that is formed into the base 140 of the deep region 104 of the base body 102 and slopes towards the supporting surface 288.

The spacing between the contact surface 284 on the base 140 of the base body 102 and the base-body-side latching elements 278 on the one hand and the length of the oil suction pipe 242 below the pipe-side latching elements 280 on the other are matched to one another in such a way that the oil suction pipe 242 is biased such as to be clamped between the base-body-side latching elements 278 and the base 140 of the base body 102.

Due to being clamped between the lead-through 240 and the base 140 of the oil pan 100 in this way, the oil suction pipe 242 is fixed in its position relative to the base body 102.

Hereby, the oil suction pipe 242 is curved by the clamping force towards the supporting surface 288 in such a way that it matches the contour thereof and is thereby prevented from slipping laterally relative to the supporting surface 288.

The process of bringing the oil suction pipe 242 into this clamping position on the base body 102 is facilitated due to the fact that the oil suction pipe 242 has already been provided with a slight pre-curvature prior to being mounted on the base body 102, namely, in the sense that the longitudinal axis 252 of the lower section of the oil suction pipe 242 is pre-curved towards the side of the oil suction pipe 242 remote from the positioning recess 260 in the support collar 254.

This pre-curvature of the oil suction pipe 242 facilitates the insertion of the lower end of the oil suction pipe 242 into the clamping position on the contact surface 284 and on the supporting surface 288 of the base 140.

The oil suction pipe 242 is preferably formed from a thermoplastic synthetic material, and in particular from a polyamide such as the polyamide 6.6 for example.

It is particularly expedient, if the oil suction pipe 242 is formed from a glass-fibre reinforced synthetic material, and in particular from a glass-fibre reinforced polyamide.

The oil suction pipe 242 is preferably formed in one piece manner.

In particular, the oil suction pipe 242 can be manufactured by an injection moulding process.

The base body 102 of the oil pan 100 is also preferably formed in one piece manner.

The base body 102 is preferably formed from a thermoplastic synthetic material, for example, from a polyamide and in particular from the polyamide 6.6.

Furthermore, provision is preferably made for the base body 102 to be formed from a glass-fibre reinforced synthetic material, and in particular from a glass-fibre reinforced polyamide.

The base body 102 can be manufactured in an injection moulding process, in particular in a cascade injection moulding process.

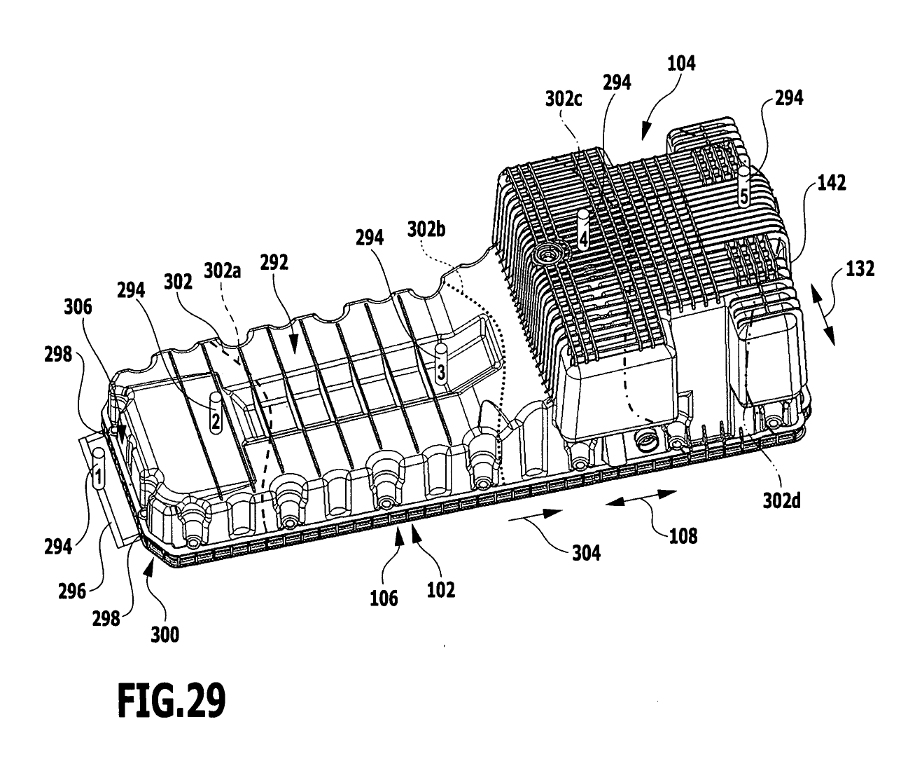

Such a cascade injection moulding process is schematically illustrated in FIG. 29.

The method is carried out by means of a multipart injection mould which is of complementary shape to that desired for the base body 102 that is to be manufactured and comprises a cavity 292 corresponding to the base body 102 being formed.

A flowable starting material and in particular a molten synthetic material is arranged to be supplied to the cavity 292 by means of a plurality of nozzles 294 which are numbered as nozzles 1 to 5 in FIG. 29.

The nozzles 294 either open out directly into the cavity 292 as in the case of the nozzles 2 to 5, or else, as in the case of the nozzle 1, open out into a supply line 296 which branches out and flows into the cavity 292 at a plurality of, two for example, discharge openings 298.

As can be seen from FIG. 29, the discharge openings 298 of the supply line 296 to which the nozzle 1 is attached preferably open out into a flange region 300 of the cavity 292 which corresponds to the mounting flange 150 of the base body 102 that is to be formed.

In the cascade injection moulding process, the cavity 292 of the injection mould is sequentially filled with the flowable starting material by the nozzles 1 to 5, whereby the nozzles are opened in timed succession by a (not illustrated) control device by means of which closure devices for the nozzles (electromagnetic valves for example) are controllable, namely, in such a manner that the flow front 302 of the starting material entering the cavity 292 from a previously opened nozzle has already reached or even passed the next nozzle to be opened, before this further nozzle is opened.

In this way, there is just one single flow front 302 of the starting material moving through the cavity 292 in a filling direction 304, and so there is no development of joint lines such as arise with the conventional injection moulding process where the flow fronts of the starting material emerging from different simultaneously opened nozzles meet one another.

In a preferred embodiment of the cascade injection moulding process, the cavity 292 of the injection mould is filled sequentially along a filling direction 304 which extends from that end region 306 of the flat region 106 of the base body 102 remote from the deep region 104 of the base body 102 being manufactured to the front wall 142 of the deep region 104 of the base body 102 being manufactured.

To this end, the discharge openings of the nozzles 1 to 5 are arranged on the cavity 292 such as to succeed one another in the filling direction 304 and they are opened successively in the order in which they succeed each other along the filling direction 304.

The filling process thus begins with the opening of the nozzle 1 whose discharge openings 298 open out into the flange region 300 of the cavity 292.

Outgoing from the discharge openings 298 of the nozzle 1, the flow front 302 has reached the position indicated in FIG. 29 by the dashed line 302a after a filling time of 1.8 seconds for example and thus has already passed the discharge opening of the nozzle 2.

At this time point, the nozzle 2 is opened in order to introduce further starting material into the cavity 292.

After a total filling time of 2.9 seconds for example, the flow front 302 of the starting material has reached the position indicated in FIG. 29 by the dotted line 302b and thus has already passed the discharge opening of the nozzle 3.

At this time point, the nozzle 3 is opened in order to introduce further starting material into the cavity 292.

After a total filling time of 5.4 seconds for example, the flow front 302 has reached the position indicated in FIG. 29 by the dash-dotted line 302c and thus has already passed the discharge opening of the nozzle 4.

At this time point, the nozzle 4 is opened in order to introduce further starting material into the cavity 292.

After a total filling time of 8.0 seconds for example, the flow front 302 of the starting material has reached the position indicated in FIG. 29 by the dash-dotted line 302d and thus has already passed the discharge opening of the nozzle 5.

At this time point, the nozzle 5 is opened in order to introduce further starting material into the cavity 292.

After a total filling time of approximately 10.9 seconds for example, the entire cavity 292 is filled with the flowable starting material so that the nozzles 294 can be closed and the base body 102 made of the starting material can be taken out of the multipart injection mould after a cooling off and solidification period.

The opening time points of the nozzles 294 can be fixed beforehand so that the process of opening the nozzles is a time-controlled process.

As an alternative thereto, provision could also be made for the opening of the nozzles to be controlled by the rate of flow, i.e. a new nozzle is opened when the quantity of the flowable starting material that has been supplied to the cavity 292 has reached a certain value.

In order to make this possible, a flow rate measuring instrument is provided in a line used for supplying the starting material to the nozzles 294.

Furthermore, it is possible for the process of opening the nozzles 294 to be pressure controlled. To this end, at least one (not illustrated) pressure sensor which measures the internal pressure in the cavity 292 is provided within the cavity 292, whereby said internal pressure increases when the flow front 302 reaches the pressure sensor.

For the purposes of controlling the opening time points of a plurality of nozzles, a plurality of pressure sensors are preferably arranged in the cavity 292 each of these being assigned to a respective one of the nozzles that are to be controlled.

Due to the fact that the cavity 292 is gradually filled in a filling direction 304 which coincides with the longitudinal direction 108 of the base body 102, the effect is achieved when using a starting material containing fibres that the fibres, and in particular glass fibres are aligned predominantly substantially in parallel with the longitudinal direction 108 of the base body 102.

In this way in particular, the effect can be achieved that the fibres in the mounting flange 150 of the base body 102 are aligned substantially in parallel with the longitudinal direction 108 of the base body 102. Particularly high mechanical stability of the mounting flange 150 is thereby obtained.

Due to the fact that the first-opening nozzle 294 introduces the starting material into the flange region 300 of the cavity 292, the effect is obtained that the process of filling the flange region 300 of the cavity 292 has ended before that of filling the remaining regions of the cavity 292 commences so that the development of joint lines in the particularly highly mechanically stressed mounting flange 150 of the base body 102 being manufactured is prevented.

Furthermore, due to the utilisation of the cascade injection moulding process, the effect is achieved that the base body 102 of the oil pan 100 that has been manufactured in this way exhibits less of an incursion of the side walls towards the longitudinal centre plane 138 after it has been removed from the mould.

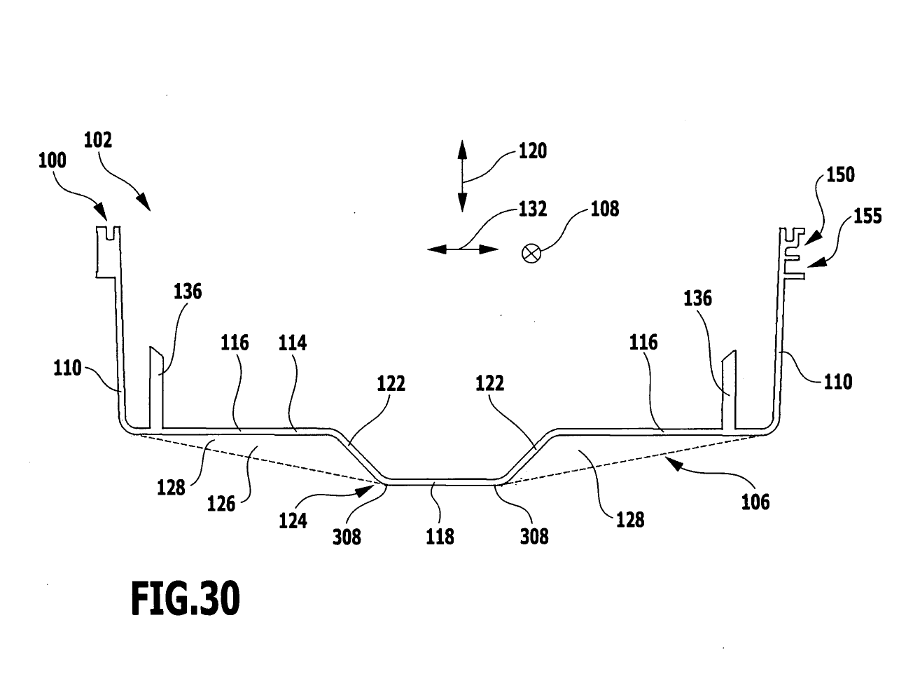

A second embodiment of a base body 102 of the oil pan 100 which is illustrated in the form of a schematic vertical cross section through the flat region 106 of the base body 102 in FIG. 30 differs from the previously described first embodiment in that the off-set base section 118 of the base 114 of the flat region 106 of the base body 102 is not displaced upwardly in relation to the lateral base sections 116 of the base 114, but rather, it is displaced downwardly towards the area outside the base body 102 so that the bulge 124 formed by the off-set base section 118 and the two adjacent connecting sections 122 projects downwardly beyond the lower surface of the base 114 of the flat region 106 of the base body 102.

In this embodiment, the connecting sections 122 are coupled to the side walls 110 by coupling elements 126 that are in the form of transverse ribs 128 each of which extends from a lateral edge 308 of the off-set base section 118 up to the nearest side wall 110 of the flat region 106, whereby, in like manner to the first embodiment, the resonant frequencies of the flat region 106 of the base body 102 are shifted to higher frequencies.

In the case of this second embodiment too, acoustic optimisation is thus obtained, this thereby decreasing the development of noise and increasing the mechanical stability of the base body 102.

The coupling elements 126 of the second embodiment are also preferably arranged to be completely outside the interior of the base body 102, being arranged only on its outer surface in order not to obstruct the flow of oil in the interior of the base body 102.

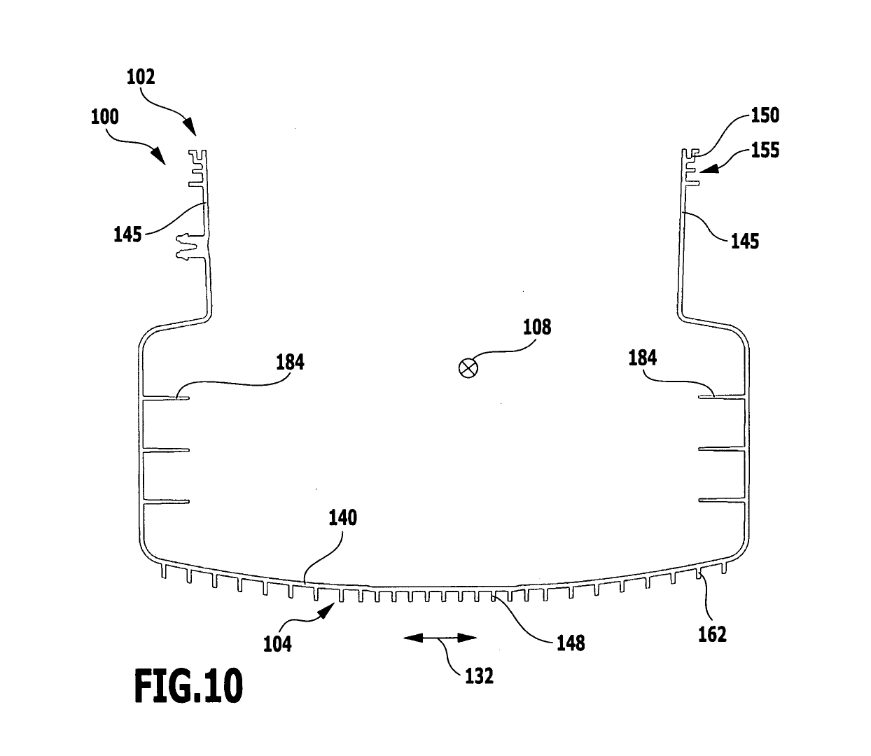

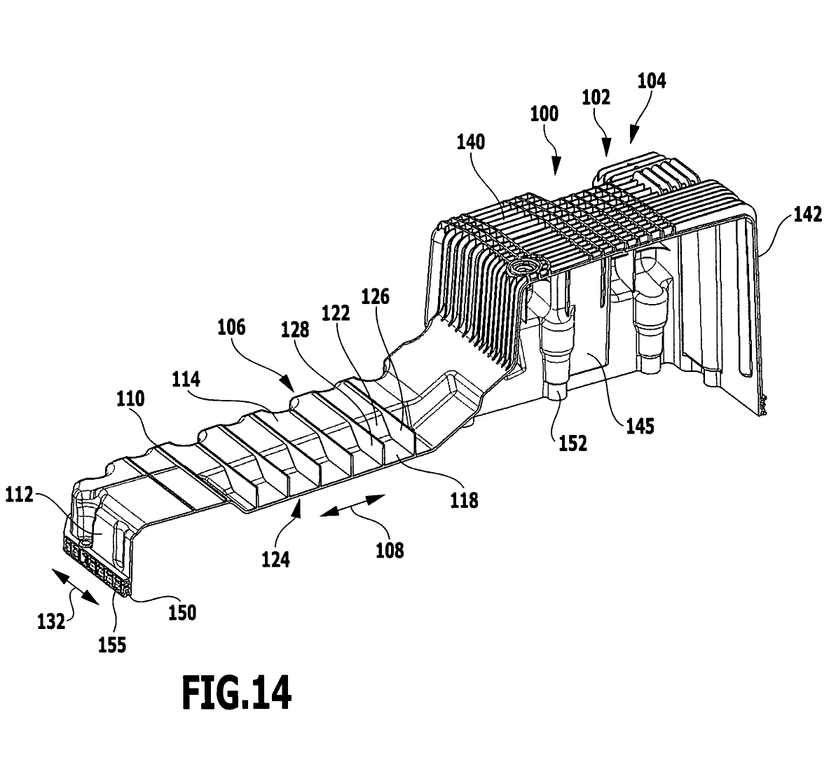

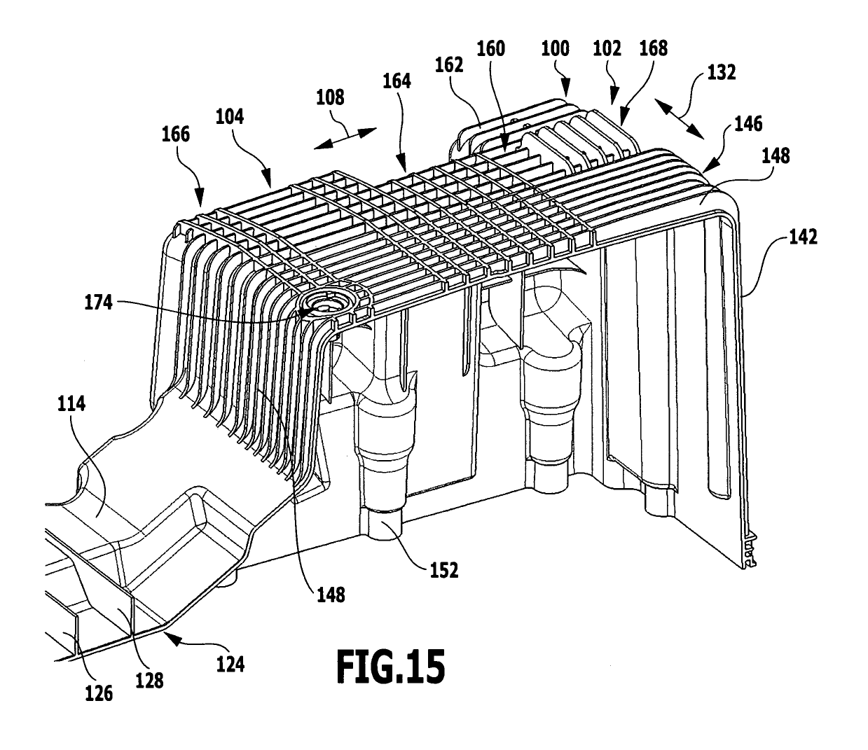

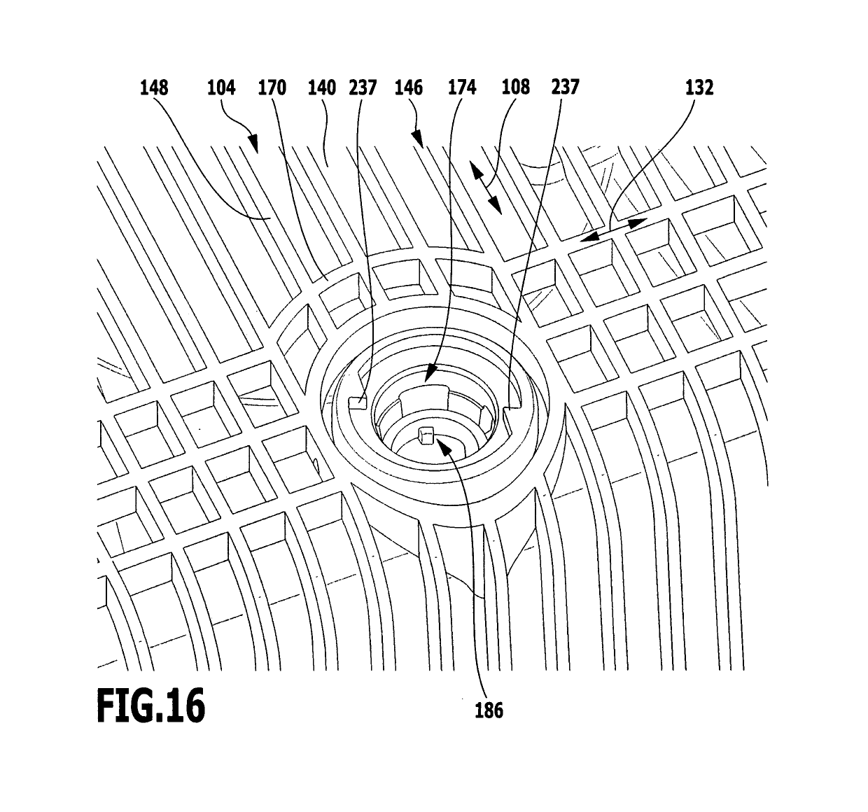

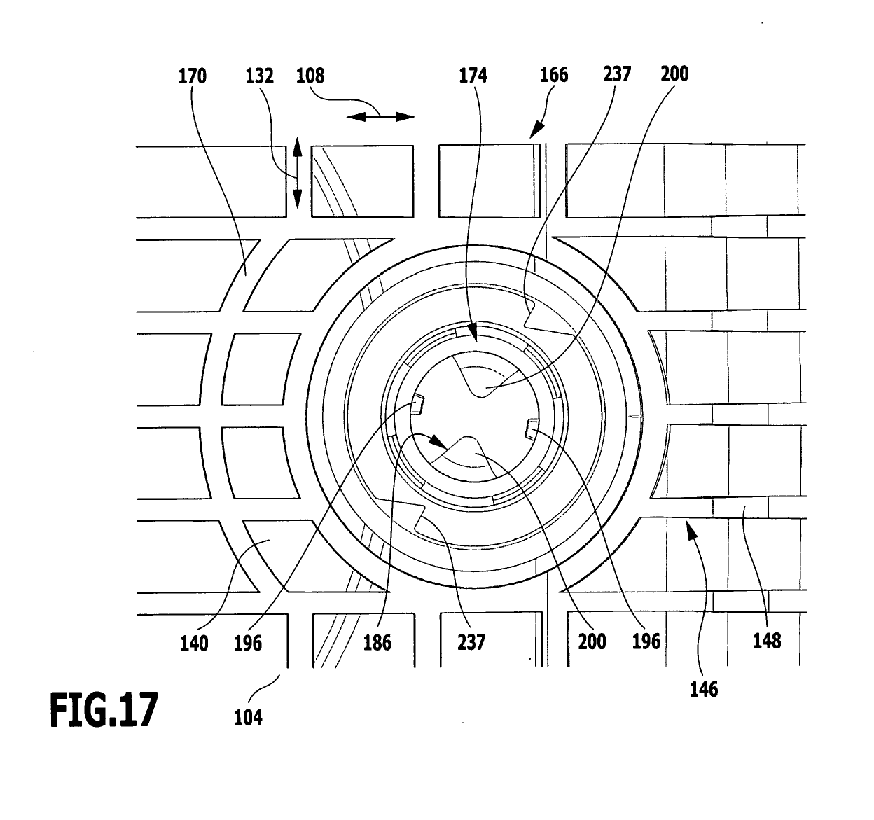

In all other respects, the second embodiment of a base body 102 of the oil pan 100 which is illustrated in FIG. 30 corresponds in regard to the construction, function, manufacturing material and mode of production with the first embodiment illustrated in FIGS. 1 to 29, and to this extent reference should be made to the preceding description.

1. A method of manufacturing a base body of an oil pan, comprising the following process step:
filling an injection mould of complementary shape to the base body with a flowable starting material in a cascade injection moulding process.

2. A method in accordance with claim 1, wherein the starting material is introduced into the injection mould through at least two mutually spaced nozzles, the nozzles being opened successively.

3. A method in accordance with claim 2, wherein a first nozzle is opened initially and a second nozzle is opened after the first nozzle with such a temporal delay that the flow front of the starting material emerging from the first nozzle has reached or already passed the second nozzle when the second nozzle is opened.

4. A method in accordance with claim 1, wherein at least three nozzles are opened successively, wherein the sequence of the nozzle opening time points corresponds to the sequential positions of the nozzles in a longitudinal direction of the base body.

5. A method in accordance with claim 1, wherein the first nozzle or the first nozzles to be opened introduce the starting material into a flange region of the injection mould in which a mounting flange of the base body of the oil pan is formed.

6. A method in accordance with claim 1, wherein the successive opening of a plurality of nozzles is controlled in dependence on the elapsed filling time.

7. A method in accordance with claim 1, wherein the successive opening of a plurality of nozzles is controlled in dependence on the quantity of starting material that has been introduced into the injection mould.

8. A method in accordance with claim 1, wherein the successive opening of a plurality of nozzles is controlled in dependence on a pressure prevailing within a cavity of the injection mould.

9. A method in accordance with claim 8, wherein the pressure within the cavity is measured by means of at least one pressure sensor.

10. A method in accordance with claim 1, wherein the base body being manufactured comprises a deep region and a flat region which extends away from the deep region in a longitudinal direction of the base body, and in that that nozzle is opened first which is closest to an end region of the flat region of the base body that is remote from the deep region of the base body of the oil pan.

11. A method in accordance with claim 1, wherein the starting material comprises a thermoplastic synthetic material.

12. A method in accordance with claim 1, wherein the starting material comprises fibres.

13. A method in accordance with claim 12, wherein the introduction of the starting material into the injection mould is effected in such a way that the preferred direction of the fibres in a flange region of the injection mould, in which a mounting flange of the base body is formed, is substantially parallel to a longitudinal direction of the base body.

14. A base body of an oil pan which is manufactured by a method comprising the following process step:
filling an injection mould of complementary shape to the base body with a flowable starting material in a cascade injection moulding process.

15. A base body in accordance with claim 14, wherein the base body comprises a fibre-reinforced synthetic material and has a mounting flange in which the preferred direction of the fibres is substantially parallel to a longitudinal direction of the base body.
